(19) United States
(12) Patent Application Publication
(10) Pub. No.: US 2024/0339879 A1
(43) Pub. Date: Oct. 10, 2024

(54) COIL ASSEMBLY, ARMATURE AND ROTATING ELECTRIC MACHINE

(71) Applicant: Denso Corporation, Kariya-city (JP)

(72) Inventors: Toshio YAMAMOTO, Kariya-city (JP); Yuji Hayashi, Kariya-city (JP)

(73) Assignee: Denso Corporation, Kariya-city (JP)

(21) Appl. No.: 18/748,532

(22) Filed: Jun. 20, 2024

Related U.S. Application Data
(63) Continuation of application No. PCT/JP2022/039787, filed on Oct. 25, 2022.

(30) Foreign Application Priority Data
Dec. 20, 2021 (JP) 2021-206305

(51) Int. Cl. H02K 3/04

(52) U.S. Cl. CPC H02K 3/04

(57) ABSTRACT

A coil assembly includes: a band member formed of an electrically-insulative material into a band shape and rolled along a circumferential direction; and a plurality of coils formed of an electroconductive material on the band member and arranged in alignment with each other along the circumferential direction. The plurality of coils have a plurality of paths through which electric current flows and which constitute parts of a closed circuit. The coil assembly also includes first and second connection portions. The first connection portion constitutes a part of the closed circuit and connects between the plurality of paths. The second connection portion constitutes another part of the closed circuit and connects between the plurality of paths so that induced currents, which are induced in the closed circuit by electromagnetic induction due to movement of magnets in the circumferential direction, are canceled out by each other in the closed circuit.

### CROSS-REFERENCE TO RELATED APPLICATIONS

The present application is a continuation application of International Application No. PCT/JP2022/039787 filed on Oct. 25, 2022, which is based on and claims priority from Japanese Patent Application No. 2021-206305 filed on Dec. 20, 2021. The entire contents of these applications are incorporated by reference into the present application.

### BACKGROUND

### 1 Technical Field

The present disclosure relates to coil assemblies, armatures and rotating electric machines.

### 2 Description of Related Art

There is disclosed, for example in Japanese Unexamined Patent Application Publication No. JP 2017-070140 A, a coil assembly that constitutes a part of an armature of a rotating electric machine. The coil assembly includes a first electroconductive cylindrical body, a second electroconductive cylindrical body, and an electrical insulator arranged between the first electroconductive cylindrical body and the second electroconductive cylindrical body. The first electroconductive cylindrical body has a plurality of first electroconductive bands extending in an axial direction thereof and arranged adjacent to and apart from one another in a circumferential direction thereof. The second electroconductive cylindrical body has a plurality of second electroconductive bands extending in an axial direction thereof and arranged adjacent to and apart from one another in a circumferential direction thereof. The electrical insulator electrically insulates the first electroconductive bands from the second electroconductive bands. With such a configuration, it is possible to achieve simplification of the configuration of the coil assembly and reduction in the cost of the coil assembly while suppressing the electrical performance of the coil assembly from being impaired.

### SUMMARY

For a motor having a coil assembly as disclosed in the aforementioned patent document, it is desired to achieve improvement in the torque of the motor while suppressing increase in the size of the motor.

The present disclosure has been accomplished in view of the above circumstances.

According to a first aspect of the present disclosure, there is provided a coil assembly which includes a band member, a plurality of coils, a first connection portion and a second connection portion. The band member is formed of an electrically-insulative material into a band shape and rolled along a circumferential direction. The plurality of coils are formed of an electroconductive material on the band member and arranged in alignment with each other along the circumferential direction. The plurality of coils have a plurality of paths through which electric current flows and which constitute parts of a closed circuit. The first connection portion constitutes a part of the closed circuit and connects between the plurality of paths. The second connection portion constitutes another part of the closed circuit and connects between the plurality of paths or between the plurality of coils so that induced currents, which are induced in the closed circuit by electromagnetic induction due to movement of magnets in the circumferential direction, are canceled out by each other in the closed circuit. Moreover, according to a second aspect of the present disclosure, there is provided an armature which includes the coil assembly according to the first aspect of the present disclosure. Furthermore, according to a third aspect of the present disclosure, there is provided a rotating electric machine which includes a stator and a rotor, wherein one of the stator and the rotor includes the armature according to the second aspect of the present disclosure, and the other of the stator and the rotor has the magnets arranged to radially face the coil assembly.

With the above configuration, it becomes possible to achieve improvement in the torque of the rotating electric machine while suppressing increase in the size of the rotating electric machine.

### BRIEF DESCRIPTION OF THE DRAWINGS

FIG. 1 is a cross-sectional view, taken along an axial direction, of a motor according to a first embodiment.

FIG. 2 is a cross-sectional view, taken along a radial direction, of the motor according to the first embodiment.

FIG. 3 is a schematic perspective view of a coil assembly.

FIG. 4 is a schematic perspective view of a band member in a rolled state.

FIG. 5 is a diagram illustrating a star connection.

FIG. 6 is a diagram illustrating connection of a plurality of coils.

FIG. 7 is a schematic diagram of a coil.

FIG. 8 is a schematic diagram showing U-phase coil subgroups offset from each other in the axial direction.

FIG. 9 is a development of the coil assembly.

FIG. 10 is a cross-sectional view of a part of the coil assembly.

FIG. 11 is a cross-sectional view of another part of the coil assembly.

FIG. 12 is a cross-sectional view of yet another part of the coil assembly.

FIG. 13 is a cross-sectional view of the coil assembly taken along the radial direction.

FIG. 14 is a cross-sectional view of a vertical-portion laminate.

FIG. 15 is a cross-sectional view of another vertical-portion laminate.

FIG. 16 is a cross-sectional view of yet another vertical-portion laminate.

FIG. 17 is a schematic diagram showing some of the coils of the motor according to the first embodiment.

FIG. 18 is an enlarged view of a second-axial-side end part of a coil.

FIG. 19 is a schematic diagram illustrating induced current that is induced in the coil as an N-pole magnet passes the coil.

FIG. 20 is a schematic diagram illustrating the induced current in a closed circuit of the coil as the N-pole magnet passes the coil.

FIG. 21 is a schematic diagram illustrating induced current that is induced in the coil as an S-pole magnet passes the coil.

FIG. 22 is a schematic diagram illustrating the induced current in the closed circuit of the coil as the S-pole magnet passes the coil.

FIG. 23 is a schematic diagram illustrating how the induced currents that are induced in the coil are canceled out by each other.

FIG. 24 is a schematic diagram illustrating how the induced currents are canceled out by each other in the closed circuit of the coil.

FIG. 25 is a graph showing the induced currents and their resultant current.

FIG. 26 is a schematic diagram showing some of coils of a motor according to a second embodiment.

FIG. 27 is a schematic diagram illustrating how induced currents that are induced in a coil of the motor according to the second embodiment are canceled out by each other.

FIG. 28 is a schematic diagram illustrating how the induced currents are canceled out by each other in a closed circuit of the coil of the motor according to the second embodiment.

FIG. 29 is a schematic diagram showing some of coils of a motor according to a third embodiment.

FIG. 30 is a schematic diagram illustrating how induced currents are canceled out by each other in a closed circuit formed in the coils of the motor according to the third embodiment.

FIG. 31 is a schematic diagram showing some of coils of a motor according to a fourth embodiment.

FIG. 32 is a schematic diagram illustrating how induced currents are canceled out by each other in a closed circuit formed in the coils of the motor according to the fourth embodiment.

FIG. 33 is a schematic diagram showing some of coils of a motor according to a fifth embodiment.

FIG. 34 is a schematic diagram illustrating how induced currents that are induced in a coil of the motor according to the fifth embodiment are canceled out by each other.

FIG. 35 is a schematic diagram illustrating how the induced currents are canceled out by each other in a closed circuit of the coil of the motor according to the fifth embodiment.

FIG. 36 is a schematic diagram showing one of coils of a motor according to a sixth embodiment.

FIG. 37 is a schematic diagram showing some of the coils of the motor according to the sixth embodiment.

FIG. 38 is a schematic diagram illustrating connection of the coils of the motor according to the sixth embodiment at a neutral point.

FIG. 39 is a schematic diagram illustrating how induced currents are canceled out by each other in closed circuits formed in the coils of the motor according to the sixth embodiment.

FIG. 40 is a schematic diagram showing some of coils of a motor according to a seventh embodiment.

FIG. 41 is a schematic diagram illustrating how induced currents are canceled out by each other in closed circuits formed in the coils of the motor according to the seventh embodiment.

FIG. 42 is a schematic diagram showing some of coils of a motor according to an eighth embodiment.

FIG. 43 is a schematic diagram illustrating how induced currents are canceled out by each other in closed circuits formed in the coils of the motor according to the eighth embodiment.

FIG. 44 is a schematic diagram showing some of coils of a motor according to a ninth embodiment.

FIG. 45 is a schematic diagram illustrating how induced currents are canceled out by each other in closed circuits formed in the coils of the motor according to the ninth embodiment.

FIG. 46 is a schematic diagram showing a cross section of a coil assembly of a motor according to a tenth embodiment.

FIG. 47 is a schematic diagram showing some of coils of the motor according to the tenth embodiment.

FIG. 48 is a schematic diagram illustrating how induced currents are canceled out by each other in closed circuits formed in the coils of the motor according to the tenth embodiment.

FIG. 49 is a schematic diagram showing one of coils of a motor according to an eleventh embodiment.

### DESCRIPTION OF EMBODIMENTS

### First Embodiment

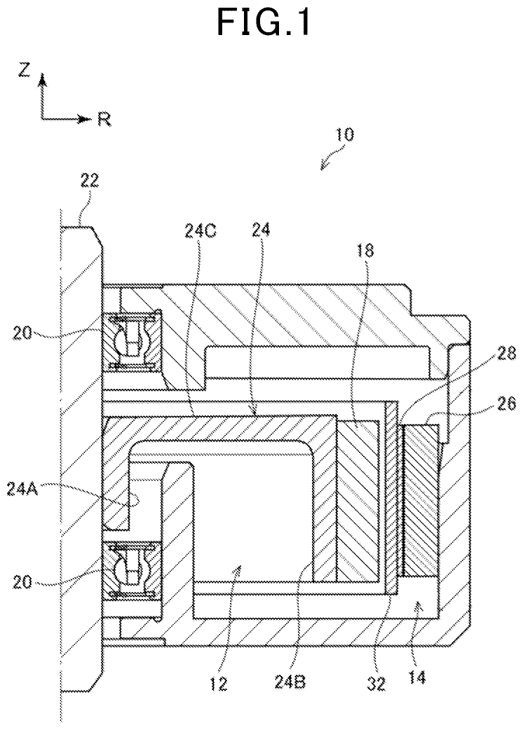

A motor 10 according to the first embodiment of the present disclosure will be described with reference to FIGS. 1 to 25. It should be noted that the arrows Z, R and C suitably shown in the drawings respectively indicate a first side in a rotation axial direction, the outer side in a rotation radial direction and a first side in a rotation circumferential direction of a rotor 12 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 12. In addition, the motor 10 according to the present embodiment and motors according to embodiments to be described later are examples of rotating electric machines.

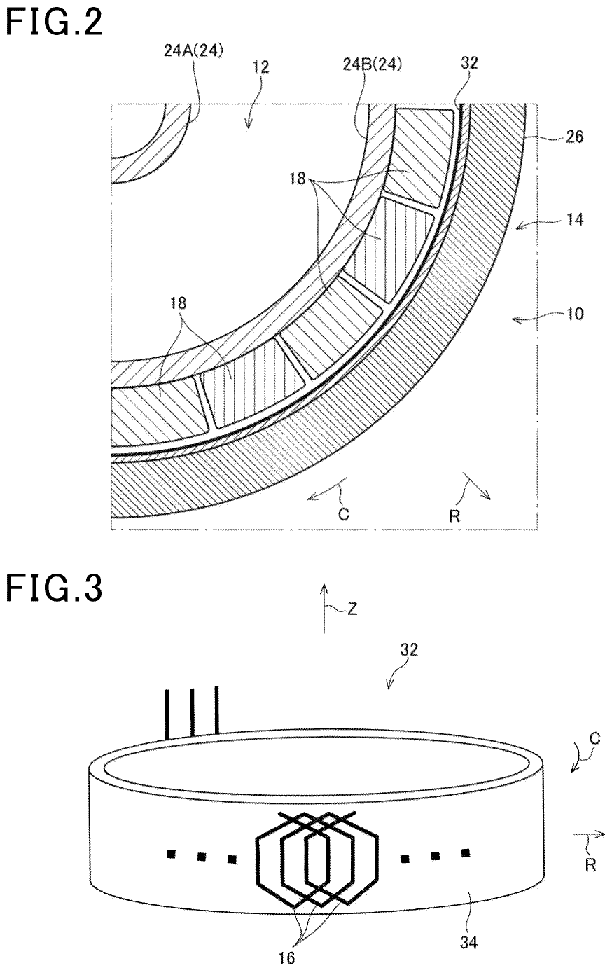

As shown in FIGS. 1 and 2, in the present embodiment, the motor 10 is configured as an inner rotor type brushless motor in which the rotor 12 is arranged radially inside a stator 14 that serves as an armature. It should be noted that: FIGS. 1 and 2 merely illustrate an example of the motor 10; and there may be some inconsistencies in the number of coils 16, the number of magnets 18 and the shapes of details between these figures and the later explanation of the motor 10.

The rotor 12 includes a rotating shaft 22 that is rotatably supported by a pair of bearings 20, a rotor core 24 that is formed in a bottomed cylindrical shape and fixed to the rotating shaft 22, and a plurality of magnets 18 fixed to a radially outer surface of the rotor core 24.

The rotor core 24 has a first cylindrical part 24A fixed onto the rotating shaft 22 by press-fitting or the like, a second cylindrical part 24B located radially outside the first cylindrical part 24A, and a discoid connection plate part 24C that radially connects an end portion of the first cylindrical part 24A on the first side in the axial direction and an end portion of the second cylindrical part 24B on the first side in the axial direction. An outer circumferential surface (i.e., a radially outer surface) of the second cylindrical part 24B is formed as a cylindrical surface along the circumferential direction. To the outer circumferential surface of the second cylindrical part 24B, there are fixed the magnets 18 which will be described later.

The magnets 18 are formed of a magnetic compound whose intrinsic coercive force Hc is higher than or equal to 400 [kA/m] and whose residual flux density Br is higher than or equal to 1.0 [T]. For example, the magnets 18 may be formed of a magnetic compound such as NdFe₁₁TIN, Nd₂Fe₁₄B, Sm₂Fe₁₇N₃ or FeNi. Moreover, as mentioned above, the magnets 18 are fixed to the outer circumferential surface of the second cylindrical part 24B of the rotor core 24. Furthermore, those magnets 18 each of which has a radially outer surface forming an N pole and those magnets 18 each of which has a radially outer surface forming an S pole are arranged alternately in the circumferential direction. In addition, the number of the magnets 18 may be suitably set in consideration of the output and the like required of the motor 10.

The stator 14 includes an annular stator core 26 that serves as an armature core, an insulator 28 mounted to the stator core 26 by bonding or fitting, and a coil assembly 32 mounted to the stator core 26 via the insulator 28. As shown in FIGS. 1 to 3, in the present embodiment, the stator 14 has a toothless structure such that no part of the stator core 26 is arranged inside the coils 16 each constituting a part of the coil assembly 32.

As shown in FIGS. 1 and 2, the stator core 26 is formed of a soft-magnetic material, such as steel, into an annular shape. The stator core 26 is arranged coaxially with the rotor 12; and the axial center position of the stator core 26 coincides in the axial direction with the axial center positions of the magnets 18 fixed to the rotor core 24.

As shown in FIG. 1, the insulator 28 is formed of an electrically-insulative material such as a resin material. In a state of having been mounted to the stator core 26, the insulator 28 covers a radially inner surface of the stator core 26. It should be noted that the insulator 28 is not shown in FIG. 2.

As shown in FIG. 3, the coil assembly 32 according to the present embodiment includes a band member 34 that is formed of an electrically-insulative material into a band shape, and the coils 16 formed on the band member 34.

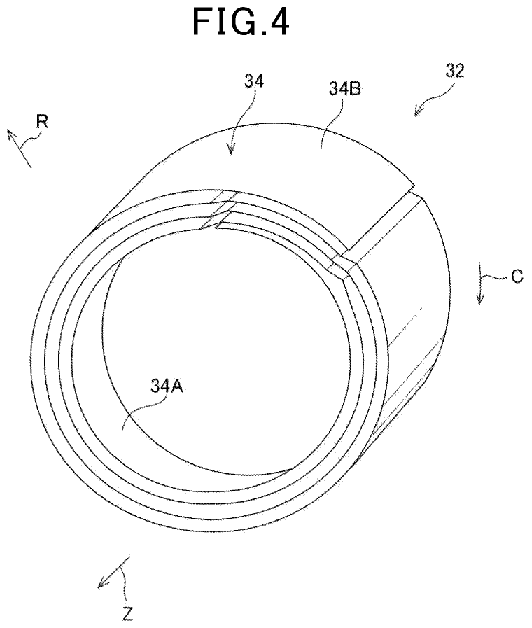

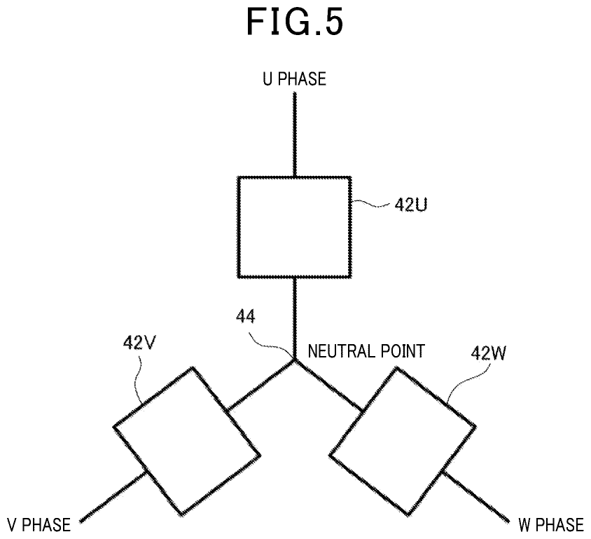

As shown in FIG. 4, the band member 34 is formed in a rectangular shape whose lateral direction coincides with the axial direction and whose longitudinal direction coincides with a direction perpendicular to the axial direction. The thickness of the band member 34 is set to such a thickness as to allow the band member 34 to be bent in the circumferential direction. In the present embodiment, the band member 34, which is a single band member, is rolled along the circumferential direction a plurality of times into a cylindrical shape. In addition, in the present embodiment, most of the band member 34 has four layers in the radial direction. Alternatively, the coil assembly 32 may be composed of a plurality of band members 34 rolled in an annular shape. For example, the coil assembly 32 may be composed of four band members 34 which have different inner and outer diameters from each other. By repeating the process of placing one of the band members 34 radially inside another one of the band members 34, the coil assembly 32 may be formed which has four layers in the radial direction.

As shown in FIG. 3, the coils 16 are formed on the band member 34. Moreover, as shown in FIGS. 3 and 4, the band member 34 is rolled along the circumferential direction a plurality of times so that the coils 16 are located at predetermined positions in the circumferential direction and the radial direction.

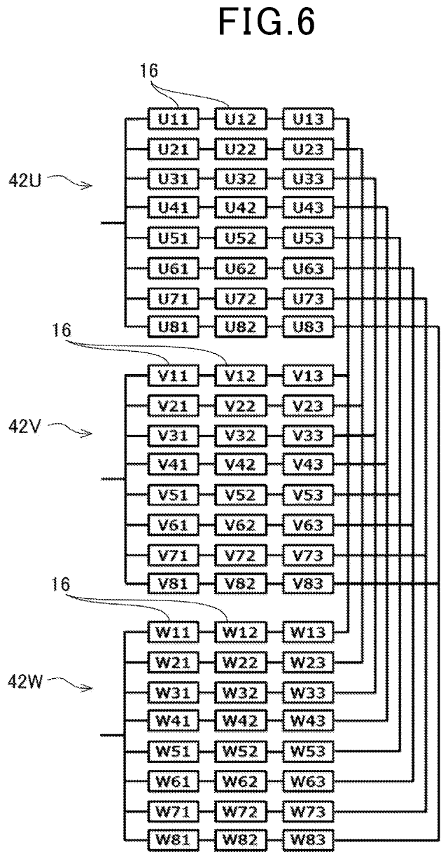

In the present embodiment, as shown in FIG. 5, those coils 16 which together constitute a U phase (or U-phase coil group 42U), those coils 16 which together constitute a V phase (or V-phase coil group 42V) and those coils 16 which together constitute a W phase (or W-phase coil group 42W) are star-connected. Specifically, as shown in FIG. 6, twenty-four coils 16 constituting the U-phase coil group 42U, twenty-four coils 16 constituting the V-phase coil group 42V and twenty-four coils 16 constituting the W-phase coil group 42W are star-connected.

Hereinafter, the twenty-four coils 16 constituting the U-phase coil group 42U will be designated respectively by reference signs U11, U12, U13, U21, U22, U23, U31, U32, U33, U41, U42, U43, U51, U52, U53, U61, U62, U63, U71, U72, U73, U81, U82 and U83.

Moreover, the twenty-four coils 16 constituting the V-phase coil group 42V will be designated respectively by reference signs V11, V12, V13, V21, V22, V23, V31, V32, V33, V41, V42, V43, V51, V52, V53, V61, V62, V63, V71, V72, V73, V81, V82 and V83.

Furthermore, the twenty-four coils 16 constituting the W-phase coil group 42W will be designated respectively by reference signs W11, W12, W13, W21, W22, W23, W31, W32, W33, W41, W42, W43, W51, W52, W53, W61, W62, W63, W71, W72, W73, W81, W82 and W83.

It should be noted that in the following explanation, specific coils 16 will be represented only by the reference signs depending on the situation.

The U-phase coils U11, U12 and U13 are connected in series with each other. The U-phase coils U21, U22 and U23 are connected in series with each other. The U-phase coils U31, U32 and U33 are connected in series with each other. The U-phase coils U41, U42 and U43 are connected in series with each other. The U-phase coils U51, U52 and U53 are connected in series with each other. The U-phase coils U61, U62 and U63 are connected in series with each other. The U-phase coils U71, U72 and U73 are connected in series with each other. The U-phase coils U81, U82 and U83 are connected in series with each other.

Moreover, an end of the U-phase coil U11 on a side not connected to the U-phase coil U12, an end of the U-phase coil U21 on a side not connected to the U-phase coil U22, an end of the U-phase coil U31 on a side not connected to the U-phase coil U32, an end of the U-phase coil U41 on a side not connected to the U-phase coil U42, an end of the U-phase coil U51 on a side not connected to the U-phase coil U52, an end of the U-phase coil U61 on a side not connected to the U-phase coil U62, an end of the U-phase coil U71 on a side not connected to the U-phase coil U72 and an end of the U-phase coil U81 on a side not connected to the U-phase coil U82 are connected with each other.

The V-phase coils V11, V12 and V13 are connected in series with each other. The V-phase coils V21, V22 and V23 are connected in series with each other. The V-phase coils V31, V32 and V33 are connected in series with each other. The V-phase coils V41, V42 and V43 are connected in series with each other. The V-phase coils V51, V52 and V53 are connected in series with each other. The V-phase coils V61, V62 and V63 are connected in series with each other. The V-phase coils V71, V72 and V73 are connected in series with each other. The V-phase coils V81, V82 and V83 are connected in series with each other.

Moreover, an end of the V-phase coil V11 on a side not connected to the V-phase coil V12, an end of the V-phase coil V21 on a side not connected to the V-phase coil V22, an end of the V-phase coil V31 on a side not connected to the V-phase coil V32, an end of the V-phase coil V41 on a side not connected to the V-phase coil V42, an end of the V-phase coil V51 on a side not connected to the V-phase coil V52, an end of the V-phase coil V61 on a side not connected to the V-phase coil V62, an end of the V-phase coil V71 on a side not connected to the V-phase coil V72 and an end of the V-phase coil V81 on a side not connected to the V-phase coil V82 are connected with each other.

The W-phase coils W11, W12 and W13 are connected in series with each other. The W-phase coils W21, W22 and W23 are connected in series with each other. The W-phase coils W31, W32 and W33 are connected in series with each other. The W-phase coils W41, W42 and W43 are connected in series with each other. The W-phase coils W51, W52 and W53 are connected in series with each other. The W-phase coils W61, W62 and W63 are connected in series with each other. The W-phase coils W71, W72 and W73 are connected in series with each other. The W-phase coils W81, W82 and W83 are connected in series with each other.

Moreover, an end of the W-phase coil W11 on a side not connected to the W-phase coil W12, an end of the W-phase coil W21 on a side not connected to the W-phase coil W22, an end of the W-phase coil W31 on a side not connected to the W-phase coil W32, an end of the W-phase coil W41 on a side not connected to the W-phase coil W42, an end of the W-phase coil W51 on a side not connected to the W-phase coil W52, an end of the W-phase coil W61 on a side not connected to the W-phase coil W62, an end of the W-phase coil W71 on a side not connected to the W-phase coil W72 and an end of the W-phase coil W81 on a side not connected to the W-phase coil W82 are connected with each other.

An end of the U-phase coil U13 on a side not connected to the U-phase coil U12, an end of the V-phase coil V13 on a side not connected to the V-phase coil V12 and an end of the W-phase coil W13 on a side not connected to the W-phase coil W12 are connected with each other.

An end of the U-phase coil U23 on a side not connected to the U-phase coil U22, an end of the V-phase coil V23 on a side not connected to the V-phase coil V22 and an end of the W-phase coil W23 on a side not connected to the W-phase coil W22 are connected with each other.

An end of the U-phase coil U33 on a side not connected to the U-phase coil U32, an end of the V-phase coil V33 on a side not connected to the V-phase coil V32 and an end of the W-phase coil W33 on a side not connected to the W-phase coil W32 are connected with each other.

An end of the U-phase coil U43 on a side not connected to the U-phase coil U42, an end of the V-phase coil V43 on a side not connected to the V-phase coil V42 and an end of the W-phase coil W43 on a side not connected to the W-phase coil W42 are connected with each other.

An end of the U-phase coil U53 on a side not connected to the U-phase coil U52, an end of the V-phase coil V53 on a side not connected to the V-phase coil V52 and an end of the W-phase coil W53 on a side not connected to the W-phase coil W52 are connected with each other.

An end of the U-phase coil U63 on a side not connected to the U-phase coil U62, an end of the V-phase coil V63 on a side not connected to the V-phase coil V62 and an end of the W-phase coil W63 on a side not connected to the W-phase coil W62 are connected with each other.

An end of the U-phase coil U73 on a side not connected to the U-phase coil U72, an end of the V-phase coil V73 on a side not connected to the V-phase coil V72 and an end of the W-phase coil W73 on a side not connected to the W-phase coil W72 are connected with each other.

An end of the U-phase coil U83 on a side not connected to the U-phase coil U82, an end of the V-phase coil V83 on a side not connected to the V-phase coil V82 and an end of the W-phase coil W83 on a side not connected to the W-phase coil W82 are connected with each other.

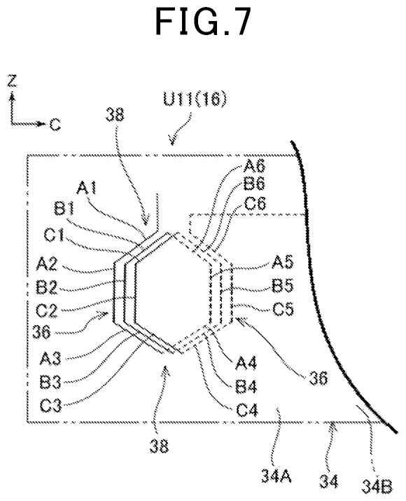

FIG. 7 schematically shows one of the U-phase coils 16. In the present embodiment, each of the coils 16 is formed to have a hexagonal shape when viewed in the thickness direction of the band member 34. Moreover, each of the coils 16 has the same configuration as a three-turn coil in which a conductor wire is wound three turns.

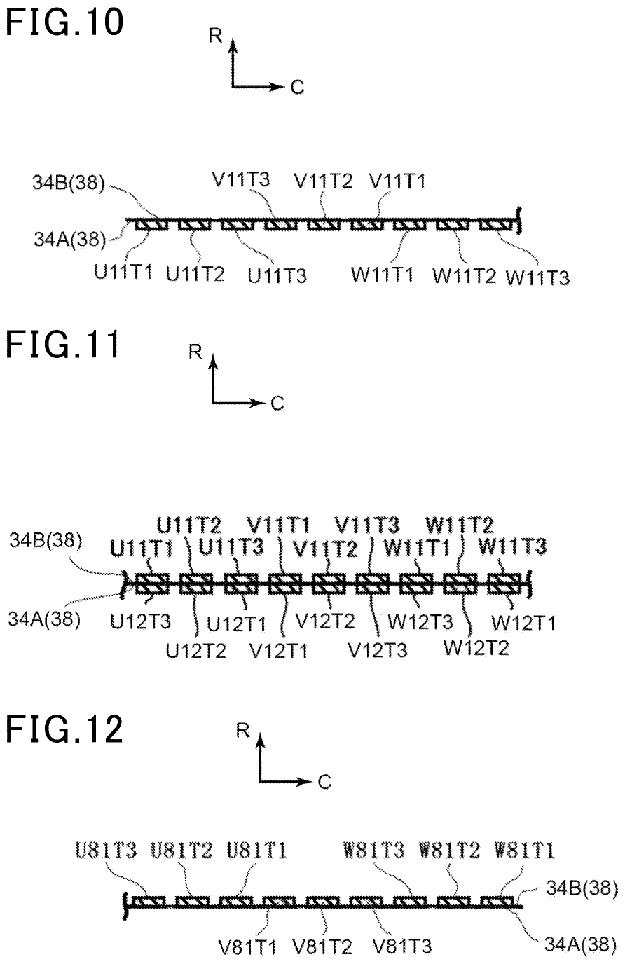

That part of the U-phase coil U11 which constitutes the first turn includes: a first straight portion A1 that is inclined toward the second side in the circumferential direction as it extends toward the second side in the axial direction; a second straight portion A2 that extends from the first straight portion A1 toward the second side in the axial direction; and a third straight portion A3 that is inclined toward the first side in the circumferential direction as it extends from the second straight portion A2 toward the second side in the axial direction. Moreover, that part of the U-phase coil U11 which constitutes the first turn also includes: a fourth straight portion A4 that is inclined toward the first side in the circumferential direction as it extends from the third straight portion A3 toward the first side in the axial direction; a fifth straight portion A5 that extends from the fourth straight portion A4 toward the first side in the axial direction; and a sixth straight portion A6 that is inclined toward the second side in the circumferential direction as it extends from the fifth straight portion A5 toward the first side in the axial direction. Furthermore, the first straight portion A1, the second straight portion A2 and the third straight portion A3 are formed on a first surface 34A (see FIG. 10) of the band member 34. On the other hand, the fourth straight portion A4, the fifth straight portion A5 and the sixth straight portion A6 are formed on a second surface 34B (see FIG. 10) of the band member 34. In addition, the third straight portion A3 and the fourth straight portion A4 are electrically connected through a via or through-hole (not shown) that penetrates the band member 34. It should be noted that in FIG. 7, those portions of the U-phase coil U11 which are formed on the first surface 34A of the band member 34 are shown by solid lines, whereas those portions of the U-phase coil U11 which are formed on the second surface 34B of the band member 34 are shown by dashed lines.

That part of the U-phase coil U11 which constitutes the second turn includes: a first straight portion B1 that is inclined toward the second side in the circumferential direction as it extends from the sixth straight portion A6 of the first turn toward the second side in the axial direction; a second straight portion B2 that extends from the first straight portion B1 toward the second side in the axial direction; and a third straight portion B3 that is inclined toward the first side in the circumferential direction as it extends from the second straight portion B2 toward the second side in the axial direction. Moreover, that part of the U-phase coil U11 which constitutes the second turn also includes: a fourth straight portion B4 that is inclined toward the first side in the circumferential direction as it extends from the third straight portion B3 toward the first side in the axial direction; a fifth straight portion B5 that extends from the fourth straight portion B4 toward the first side in the axial direction; and a sixth straight portion B6 that is inclined toward the second side in the circumferential direction as it extends from the fifth straight portion B5 toward the first side in the axial direction. Furthermore, the sixth straight portion A6 and the first straight portion B1 are electrically connected through a via or through-hole (not shown) that penetrates the band member 34. Similarly, the third straight portion B3 and the fourth straight portion B4 are electrically connected through a via or through-hole (not shown) that penetrates the band member 34.

That part of the U-phase coil U11 which constitutes the third turn includes: a first straight portion C1 that is inclined toward the second side in the circumferential direction as it extends from the sixth straight portion B6 of the second turn toward the second side in the axial direction; a second straight portion C2 that extends from the first straight portion C1 toward the second side in the axial direction; and a third straight portion C3 that is inclined toward the first side in the circumferential direction as it extends from the second straight portion C2 toward the second side in the axial direction. Moreover, that part of the U-phase coil U11 which constitutes the third turn also includes: a fourth straight portion C4 that is inclined toward the first side in the circumferential direction as it extends from the third straight portion C3 toward the first side in the axial direction; a fifth straight portion C5 that extends from the fourth straight portion C4 toward the first side in the axial direction; and a sixth straight portion C6 that is inclined toward the second side in the circumferential direction as it extends from the fifth straight portion C5 toward the first side in the axial direction. Furthermore, the sixth straight portion B6 and the first straight portion C1 are electrically connected through a via or through-hole (not shown) that penetrates the band member 34. Similarly, the third straight portion C3 and the fourth straight portion C4 are electrically connected through a via or through-hole (not shown) that penetrates the band member 34.

That part (i.e., the first straight portion B1 to the sixth straight portion B6) of the U-phase coil U11 which constitutes the second turn is offset to the first side in the circumferential direction from that part (i.e., the first straight portion A1 to the sixth straight portion A6) of the U-phase coil U11 which constitutes the first turn. Further, that part (i.e., the first straight portion C1 to the sixth straight portion C6) of the U-phase coil U11 which constitutes the third turn is offset to the first side in the circumferential direction from that part (i.e., the first straight portion B1 to the sixth straight portion B6) of the U-phase coil U11 which constitutes the second turn.

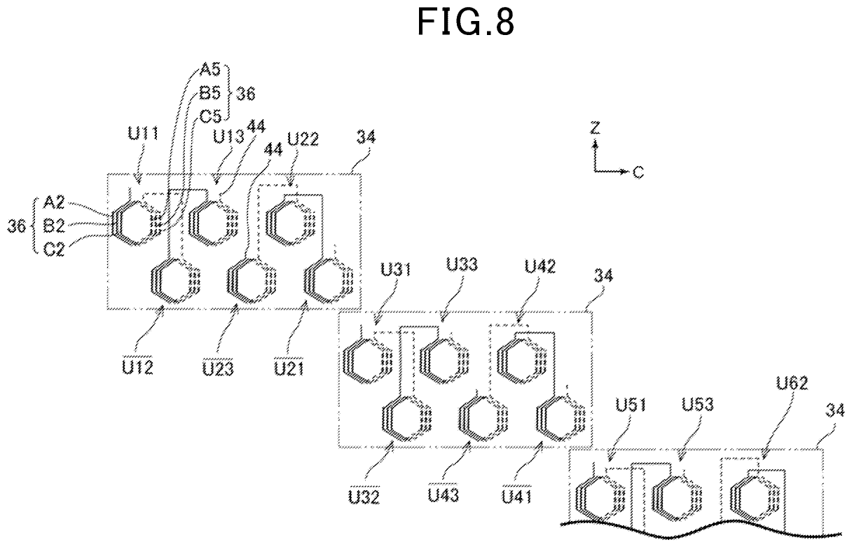

Moreover, as shown in FIGS. 7 and 8, the other U-phase coils (U12, . . . , U8 3) are also configured in the same manner as the U-phase coil U11. That is, all the U-phase coils (U11, . . . , U83) have the same configuration. It should be noted that the second straight portions A2, B2 and C2 and the fifth straight portions A5, B5 and C5 described above may be referred to as vertical portions 36. It also should be noted that: the first straight portions A1, B1 and C1 and the sixth straight portions A6, B6 and C6 may be referred to as first coil end portions 38; and the third straight portions A3, B3 and C3 and the fourth straight portions A4, B4 and C4 may be referred to as second coil end portions 38.

FIG. 8 is a schematic diagram showing U-phase coil subgroups offset from each other in the axial direction. One of the U-phase coil subgroups includes the U-phase coil U11; and another one of the U-phase coil subgroups includes the U-phase coil U12.

As shown in FIG. 8 and FIG. 7, the fifth straight portion A5, the fifth straight portion B5 and the fifth straight portion C5 of the U-phase coil U11 are located respectively at the same circumferential positions as the second straight portion A2, the second straight portion B2 and the second straight portion C2 of the U-phase coil U12. That is, the fifth straight portion A5, the fifth straight portion B5 and the fifth straight portion C5 of the U-phase coil U11 respectively overlap the second straight portion A2, the second straight portion B2 and the second straight portion C2 of the U-phase coil U12 via the band member 34.

Moreover, the fifth straight portion A5, the fifth straight portion B5 and the fifth straight portion C5 of the U-phase coil U12 are located respectively at the same circumferential positions as the second straight portion A2, the second straight portion B2 and the second straight portion C2 of the U-phase coil U13. That is, the fifth straight portion A5, the fifth straight portion B5 and the fifth straight portion C5 of the U-phase coil U12 respectively overlap the second straight portion A2, the second straight portion B2 and the second straight portion C2 of the U-phase coil U13 via the band member 34.

Furthermore, the fifth straight portion A5, the fifth straight portion B5 and the fifth straight portion C5 of the U-phase coil U13 are located respectively at the same circumferential positions as the second straight portion A2, the second straight portion B2 and the second straight portion C2 of the U-phase coil U23. That is, the fifth straight portion A5, the fifth straight portion B5 and the fifth straight portion C5 of the U-phase coil U13 respectively overlap the second straight portion A2, the second straight portion B2 and the second straight portion C2 of the U-phase coil U23 via the band member 34.

Furthermore, the fifth straight portion A5, the fifth straight portion B5 and the fifth straight portion C5 of the U-phase coil U23 are located respectively at the same circumferential positions as the second straight portion A2, the second straight portion B2 and the second straight portion C2 of the U-phase coil U22. That is, the fifth straight portion A5, the fifth straight portion B5 and the fifth straight portion C5 of the U-phase coil U23 respectively overlap the second straight portion A2, the second straight portion B2 and the second straight portion C2 of the U-phase coil U22 via the band member 34.

Furthermore, the fifth straight portion A5, the fifth straight portion B5 and the fifth straight portion C5 of the U-phase coil U22 are located respectively at the same circumferential positions as the second straight portion A2, the second straight portion B2 and the second straight portion C2 of the U-phase coil U21. That is, the fifth straight portion A5, the fifth straight portion B5 and the fifth straight portion C5 of the U-phase coil U22 respectively overlap the second straight portion A2, the second straight portion B2 and the second straight portion C2 of the U-phase coil U21 via the band member 34.

The U-phase coils U11, U12, U13, U23, U22 and U21 described above are arranged in this order on the first lap of the rolled band member 34. That is, the U-phase coils U11, U12, U13, U23, U22 and U21 are arranged in this order on the closest layer of the rolled band member 34 to the rotor 12.

Moreover, the sixth straight portion C6 of the U-phase coil U11 and the sixth straight portion C6 of the U-phase coil U12 are connected with each other. The first straight portion A1 of the U-phase coil U12 and the first straight portion A1 of the U-phase coil U13 are connected with each other. The sixth straight portion C6 of the U-phase coil U23 and the sixth straight portion C6 of the U-phase coil U22 are connected with each other. The first straight portion A1 of the U-phase coil U22 and the first straight portion A1 of the U-phase coil U21 are connected with each other. Consequently, in the present embodiment, although the U-phase coils U11, U12, U13, U23, U22 and U21 are physically configured as coils wound in one direction (or as left-handed coils to be described later), the U-phase coils U12, U23 and U21 will function identically to coils wound in the opposite direction to the U-phase coils U11, U13 and U22 (or identically to right-handed coils) when the U-phase coils U11, U12, U13, U23, U22 and U21 are energized. Hereinafter, for the sake of convenience of explanation, coils corresponding to the U-phase coils U11, U13 and U22 will be referred to as the “left-handed coils”; and coils corresponding to the U-phase coils U12, U23 and U21 will be referred to as the “right-handed coils”. In addition, in FIG. 8, lines (or bars) are attached to the reference signs U12, U23 and U21 designating the right-handed coils. Moreover, in the present embodiment, the left-handed coils and the right-handed coils are arranged alternately in the circumferential direction.

Similarly, the fifth straight portion A5, the fifth straight portion B5 and the fifth straight portion C5 of the U-phase coil U31 are located respectively at the same circumferential positions as the second straight portion A2, the second straight portion B2 and the second straight portion C2 of the U-phase coil U32. That is, the fifth straight portion A5, the fifth straight portion B5 and the fifth straight portion C5 of the U-phase coil U31 respectively overlap the second straight portion A2, the second straight portion B2 and the second straight portion C2 of the U-phase coil U32 via the band member 34.

Moreover, the fifth straight portion A5, the fifth straight portion B5 and the fifth straight portion C5 of the U-phase coil U32 are located respectively at the same circumferential positions as the second straight portion A2, the second straight portion B2 and the second straight portion C2 of the U-phase coil U33. That is, the fifth straight portion A5, the fifth straight portion B5 and the fifth straight portion C5 of the U-phase coil U32 respectively overlap the second straight portion A2, the second straight portion B2 and the second straight portion C2 of the U-phase coil U33 via the band member 34.

Furthermore, the fifth straight portion A5, the fifth straight portion B5 and the fifth straight portion C5 of the U-phase coil U33 are located respectively at the same circumferential positions as the second straight portion A2, the second straight portion B2 and the second straight portion C2 of the U-phase coil U43. That is, the fifth straight portion A5, the fifth straight portion B5 and the fifth straight portion C5 of the U-phase coil U33 respectively overlap the second straight portion A2, the second straight portion B2 and the second straight portion C2 of the U-phase coil U43 via the band member 34.

Furthermore, the fifth straight portion A5, the fifth straight portion B5 and the fifth straight portion C5 of the U-phase coil U43 are located respectively at the same circumferential positions as the second straight portion A2, the second straight portion B2 and the second straight portion C2 of the U-phase coil U42. That is, the fifth straight portion A5, the fifth straight portion B5 and the fifth straight portion C5 of the U-phase coil U43 respectively overlap the second straight portion A2, the second straight portion B2 and the second straight portion C2 of the U-phase coil U42 via the band member 34.

Furthermore, the fifth straight portion A5, the fifth straight portion B5 and the fifth straight portion C5 of the U-phase coil U42 are located respectively at the same circumferential positions as the second straight portion A2, the second straight portion B2 and the second straight portion C2 of the U-phase coil U41. That is, the fifth straight portion A5, the fifth straight portion B5 and the fifth straight portion C5 of the U-phase coil U42 respectively overlap the second straight portion A2, the second straight portion B2 and the second straight portion C2 of the U-phase coil U41 via the band member 34.

In addition, the U-phase coils U31, U32, U33, U43, U42 and U41 described above are arranged in this order on the second lap of the rolled band member 34. Moreover, the fifth straight portion A5, the fifth straight portion B5 and the fifth straight portion C5 of the U-phase coil U21 arranged on the first lap of the rolled band member 34 are located respectively at the same circumferential positions as the second straight portion A2, the second straight portion B2 and the second straight portion C2 of the U-phase coil U31 arranged on the second lap of the rolled band member 34.

Furthermore, the U-phase coils U31, U32, U33, U43, U42 and U41 arranged on the second lap of the band member 34 are connected in the same manner as the U-phase coils U11, U12, U13, U23, U22 and U21 arranged on the first lap of the band member 34.

The U-phase coils U51 to U83 are also arranged on the band member 34 in the same manner as the U-phase coils U11 to U43 described above. Consequently, the U-phase coils U51, U52, U53, U63, U62 and U61 are arranged in this order on the third lap of the rolled band member 34; and the U-phase coils U71, U72, U73, U83, U82 and U81 are arranged in this order on the fourth lap of the rolled band member 34.

Moreover, the U-phase coils U51, U52, U53, U63, U62 and U61 arranged on the third lap of the band member 34 are connected in the same manner as the U-phase coils U11, U12, U13, U23, U22 and U21 arranged on the first lap of the band member 34. Furthermore, the U-phase coils U71, U72, U73, U83, U82 and U81 arranged on the fourth lap of the band member 34 are also connected in the same manner as the U-phase coils U11, U12, U13, U23, U22 and U21 arranged on the first lap of the band member 34.

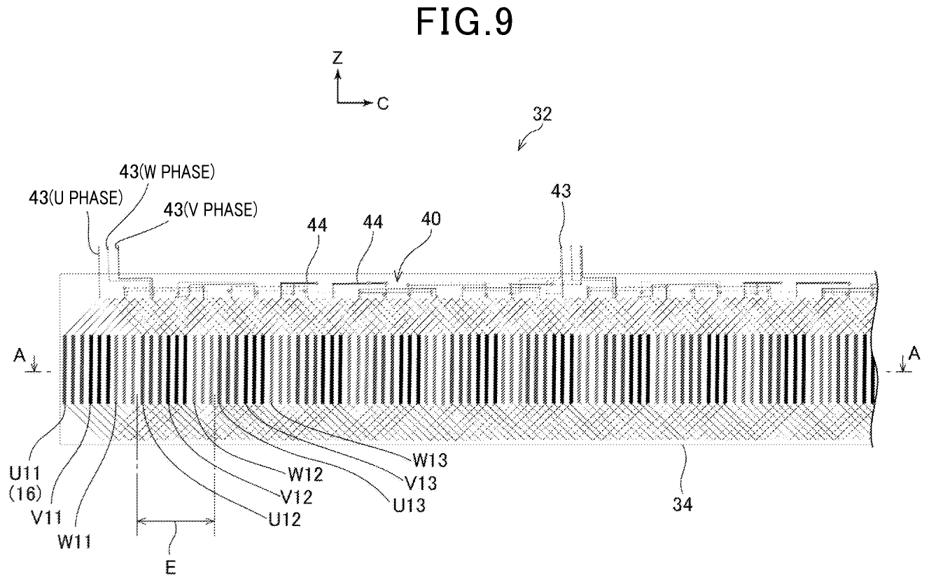

As shown in FIGS. 8 and 9, the V-phase coils V11 to V83 are also arranged on the band member 34 in the same manner as the U-phase coils U11 to U83. Moreover, the W-phase coils W11 to W83 are also arranged on the band member 34 in the same manner as the U-phase coils U11 to U83. However, the V-phase coils V11 to V83 are connected so that the winding direction of the V-phase coils is opposite to those of the U-phase coils and the W-phase coils.

Moreover, the V-phase coils V11 to V83 are offset to the first side in the circumferential direction with respect to the U-phase coils U11 to U83. Further, the W-phase coils W11 to W83 are offset to the first side in the circumferential direction with respect to the V-phase coils V11 to V83.

FIG. 10 shows a part of a cross section of the band member 34 and the coils 16 taken along the line A-A in FIG. 9. It should be noted that the part of the cross section shown in FIG. 10 includes the cross section of an end part of the band member 34 on the second side in the circumferential direction. As shown in FIG. 10, in this part of the cross section, U11T1, U11T2, U11T3, V11T3, V11T2, V11T1, W11T1, W11T2 and W11T3 are formed in this order on the first surface 34A of the band member 34. Here, reference signs T1, T2 and T3, which respectively indicate the first, second and third turns of the coils, are suffixed to the reference signs respectively designating the coils. For example, the first turn of the U-phase coil U11 is designated by the reference sign U11T1; the second turn of the U-phase coil U11 is designated by the reference sign U11T2; and the third turn of the U-phase coil U11 is designated by the reference sign U11T3.

FIG. 11 shows another part of the cross section of the band member 34 and the coils 16 taken along the line A-A in FIG. 9. It should be noted that the part of the cross section shown in FIG. 11 is that part of the cross section which is indicated by the arrow E in FIG. 9. It also should be noted that the part of the cross section shown in FIG. 11 is adjacent to the part of the cross section shown in FIG. 10 in the circumferential direction. In the part of the cross section shown in FIG. 11, U12T3, U12T2, U12T1, V12T1, V12T2, V12T3, W12T3, W12T2 and W12T1 are formed in this order on the first surface 34A of the band member 34. Moreover, in the part of the cross section shown in FIG. 11, U11T1, U11T2, U11T3, V11T3, V11T2, V11T1, W11T1, W11T2 and W11T3 are formed in this order on the second surface 34B of the band member 34.

Moreover, although not shown in the drawings, on the first side of the part of the cross section shown in FIG. 11 in the circumferential direction, the first, second and third turns of the U-phase coils (U12, U13, U23, . . . , U83, U82, U81), the V-phase coils (V12, V13, V23, . . . , V83, V82, V81) and the W-phase coils (W12, W13, W23, . . . , W83, W82, W81) are formed on the first surface 34A and the second surface 34B of the band member 34 in the same manner as shown in FIG. 11.

FIG. 12 shows yet another part of the cross section of the band member 34 and the coils 16 taken along the line A-A in FIG. 9. It should be noted that the part of the cross section shown in FIG. 12 includes the cross section of an end part of the band member 34 on the first side in the circumferential direction. As shown in FIG. 12, in this part of the cross section, U81T1, U81T2, U81T3, V81T3, V81T2, V81T1, W81T1, W81T2 and W81T3 are formed in this order on the second surface 34B of the band member 34.

Moreover, as shown in FIG. 9, the coils 16 are connected via a connection pattern section 40 provided on a part of the band member 34 on the first side in the axial direction. It should be noted that in FIG. 9, those portions of the connection pattern section 40 which are formed on the first surface 34A of the band member 34 are shown by solid lines, whereas those portions of the connection pattern section 40 which are formed on the second surface 34B of the band member 34 are shown by dashed lines. It also should be noted that in FIG. 9, those portions of the connection pattern section 40 which are designated by the reference numeral 44 represent the neutral point; and those portions of the connection pattern section 40 which are designated by the reference numeral 43 represent connection portions that are connected to a control unit (not shown). In addition, the connection between the coils 16 and the connection of the connection portions (40, 43, 44) to the control unit may be made alternatively by connection members formed separately from the band member 34, such as busbars or a printed circuit board.

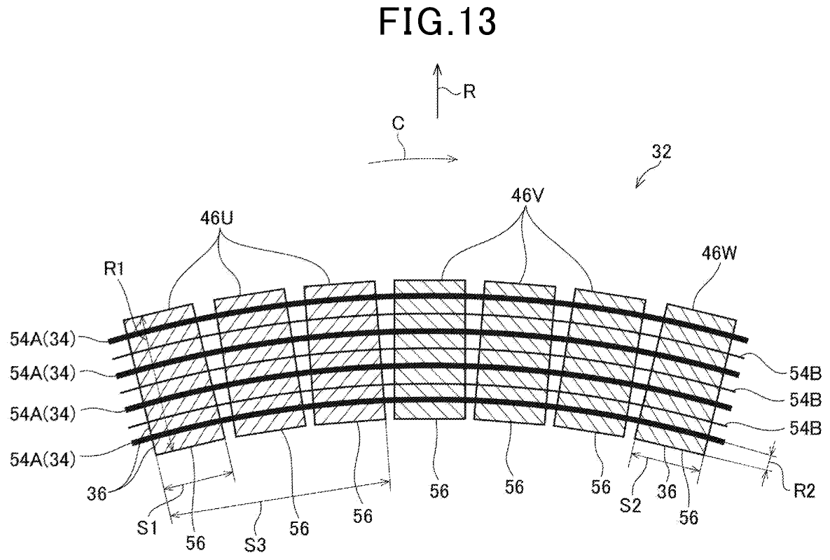

As described above, the band member 34 is rolled along the circumferential direction a plurality of times so that the coils 16 are located at predetermined positions in the circumferential direction and the radial direction. FIG. 13 shows a part of a cross section of the coil assembly 32 taken along the radial direction, where the band member 34 is in the rolled state. It should be noted that this cross section of the coil assembly 32 is a cross section corresponding to the vertical portions 36 (see FIG. 7) of the coils 16.

In the cross section shown in FIG. 13, the vertical portions 36 of the coils 16 are laminated in the radial direction and arranged at equal intervals in the circumferential direction. Moreover, in the state where the vertical portions 36 of the coils 16 are laminated in the radial direction, a first insulating layer 54A or a second insulating layer 54B is interposed between each radially-adjacent pair of the vertical portions 36. The first insulating layer 54A is constituted of the band member 34. On the other hand, the second insulating layer 54B is constituted of an insulating film that is formed to cover the coils 16 formed on the band member 34. The insulating film may be formed of, for example, an electrically-insulative paint. Hereinafter, the laminates in each of which the vertical portions 36 of the coils 16 are laminated in the radial direction will be referred to as the vertical-portion laminates 56. Each of the vertical-portion laminates 56 has a rectangular cross section along the radial direction; in the rectangular cross section, the radial dimension R1 is greater than the circumferential dimension S1. Moreover, in the present embodiment, for each of the vertical portions 36 constituting the vertical-portion laminates 56, the circumferential dimension S2 of the vertical portion 36 is set to be greater than the radial dimension R2 of the vertical portion 36.

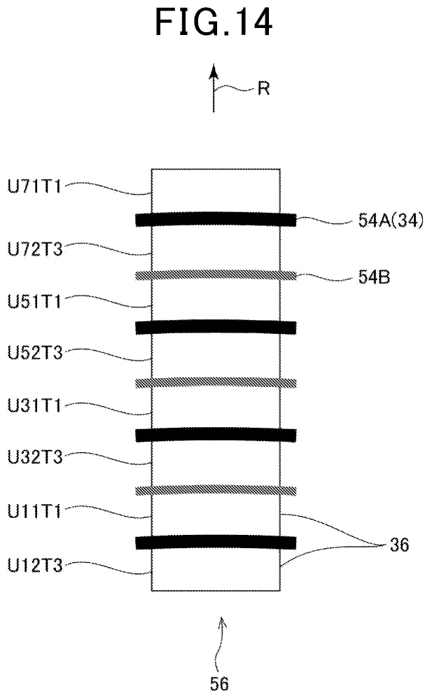

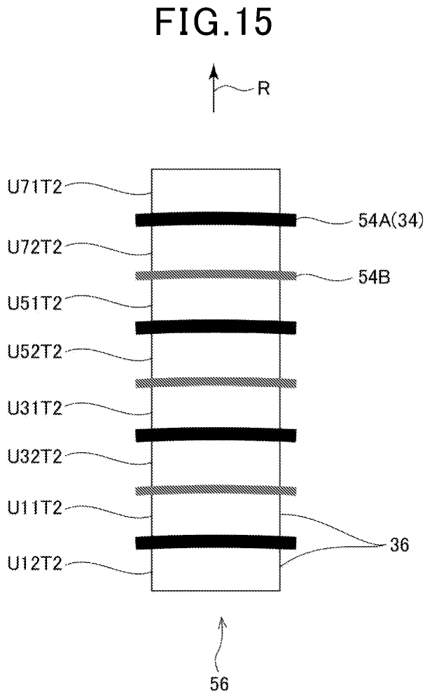

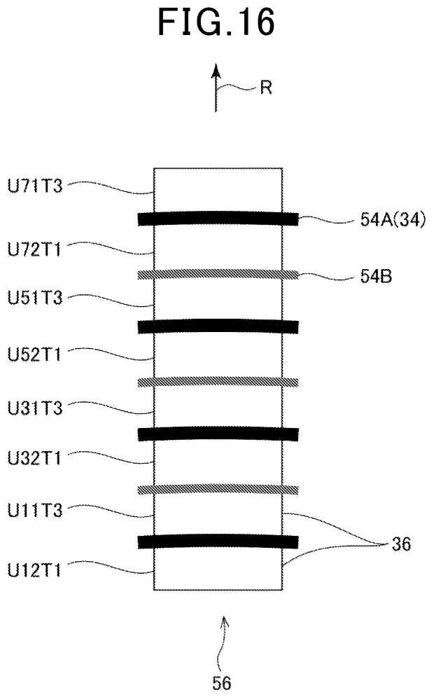

FIG. 14, FIG. 15 and FIG. 16 respectively show a vertical-portion laminate 56 in which U12T3 is located at the radially inner end, a vertical-portion laminate 56 in which U12T2 is located at the radially inner end, and a vertical-portion laminate 56 in which U12T1 is located at the radially inner end.

As shown in FIG. 14, in the vertical-portion laminate 56 in which U12T3 is located at the radially inner end, the vertical portions 36 of U12T3, U11T1, U32T3, U31T1, U52T3, U51T1, U72T3 and U71T1 are sequentially arranged in alignment with each other from the radially inner side to the radially outer side.

As shown in FIG. 15, in the vertical-portion laminate 56 in which U12T2 is located at the radially inner end, the vertical portions 36 of U12T2, U11T2, U32T2, U31T2, U52T2, U51T2, U72T2 and U71T2 are sequentially arranged in alignment with each other from the radially inner side to the radially outer side.

As shown in FIG. 16, in the vertical-portion laminate 56 in which U12T1 is located at the radially inner end, the vertical portions 36 of U12T1, U11T3, U32T1, U31T3, U52T1, U51T3, U72T1 and U71T3 are sequentially arranged in alignment with each other from the radially inner side to the radially outer side.

As shown in FIG. 13 (see also FIGS. 14 to 16), the vertical-portion laminate 56 in which U12T3 is located at the radially inner end, the vertical-portion laminate 56 in which U12T2 is located at the radially inner end, and the vertical-portion laminate 56 in which U12T1 is located at the radially inner end are arranged in this order in the circumferential direction to together constitute a U-phase conductor group 46U. In the present embodiment, the circumferential dimension S3 of the U-phase conductor group 46U at the radially inner end thereof is set to be greater than the radial dimension R1 of each of the vertical-portion laminates 56 constituting the U-phase conductor group 46U.

The vertical portions 36 of the other coils 16 are also laminated to form vertical-portion laminates 56 in the same manner as described above. Moreover, a V-phase conductor group 46V and a W-phase conductor group 46W are also formed in the same manner as the above-described U-phase conductor group 46U. In addition, the U-phase conductor group 46U, the V-phase conductor group 46V and the W-phase conductor group 46W are arranged in this order in the circumferential direction.

Next, operation and effects of the motor 10 according to the present embodiment will be described.

As shown in FIGS. 1, 2, 5 and 9, in the motor 10 according to the present embodiment, a rotating magnetic field is generated on the inner periphery of the stator 14 by switching of the energization of the U-phase coil group 42U, the V-phase coil group 42V and the W-phase coil group 42W that constitute part of the stator 14. Consequently, the rotor 12 is caused by the rotating magnetic field to rotate.

In the present embodiment, the coil assembly 32 includes the band member 34 formed of an electrically-insulative material in a band shape, and the coils 16 formed on the band member 34. Moreover, the band member 34 is rolled along the circumferential direction a plurality of times so that the coils 16 are located at predetermined positions in the circumferential direction and the radial direction. With this configuration, it becomes possible to suppress increase in the size of the coil assembly 32 in the radial direction. As a result, it becomes possible to suppress increase in the size of the motor 10.

Moreover, as shown in FIG. 13, in the present embodiment, for each of the conductor groups 46U, 46V and 46W of the respective phases, the circumferential dimension S3 of the conductor group at the radially inner end thereof (i.e., at the end thereof on the side of the magnets 18 of the rotor 12) is set to be greater than the radial dimension R1 of each of the vertical-portion laminates 56 constituting the conductor group. With the above setting, it becomes possible to reduce the radial thickness of the coil assembly 32 and thus the gap between the magnets 18 of the rotor 12 and the stator core 26. Accordingly, it becomes possible to reduce the magnetic reluctance. Consequently, it becomes possible to further improve the torque of the motor 10.

Furthermore, in the present embodiment, for each of the vertical-portion laminates 56, the radial dimension R1 of the vertical-portion laminate 56 is set to be greater than the circumferential dimension S1 of the vertical-portion laminate 56. Consequently, it becomes possible to reduce the area of each of the vertical-portion laminates 56 facing the magnets 18 of the rotor 12 while securing the cross-sectional area of each of the vertical-portion laminates 56. Thus, it becomes possible to suppress eddy current generated in the vertical-portion laminates 56 due to radial magnetic flux. As a result, it becomes possible to further improve the torque of the motor 10. Furthermore, in the present embodiment, for each of the vertical portions 36 constituting the vertical-portion laminates 56, the circumferential dimension S2 of the vertical portion 36 is set to be greater than the radial dimension R2 of the vertical portion 36. Consequently, it becomes possible to suppress eddy current generated in the vertical-portion laminates 56 due to leakage magnetic flux between the magnets 18 of the rotor 12. As a result, it becomes possible to further improve the torque of the motor 10.

Furthermore, in the present embodiment, the U-phase coils 16 are arranged in alignment with one another in the circumferential direction and all physically wound in one direction. Moreover, the U-phase coils 16 are connected so that when the U-phase coils 16 are energized, the U-phase coils 16 function identically to left-handed U-phase coils and right-handed U-phase coils which are arranged alternately in the circumferential direction. In addition, the V-phase coils 16 and the W-phase coils 16 are also configured in the same manner as the U-phase coils 16. Consequently, in the present embodiment, as shown in FIG. 14, it becomes possible to reduce the electric potential differences between the radially-laminated vertical portions 36 of the coils 16 in the vertical-portion laminates 56. Specifically, even though the vertical portions 36 having different turn numbers (T1 to T3) are arranged adjacent to each other in the radial direction, it still becomes possible to reduce the electric potential differences between the radially-laminated vertical portions 36, such as the electric potential difference between U12T3 and U11T1. Consequently, it becomes possible to improve the reliability of electrical insulation between the radially-laminated vertical portions 36 of the coils 16 in the vertical-portion laminates 56. As a result, it becomes possible to reduce the thicknesses of the first and second insulating layers 54A and 54B.

Next, explanation will be given of a configuration for suppressing loss caused by induced currents. It should be noted that the configuration for suppressing loss caused by induced currents, which will be explained below, is not reflected in FIGS. 1 to 16 used in the above explanation.

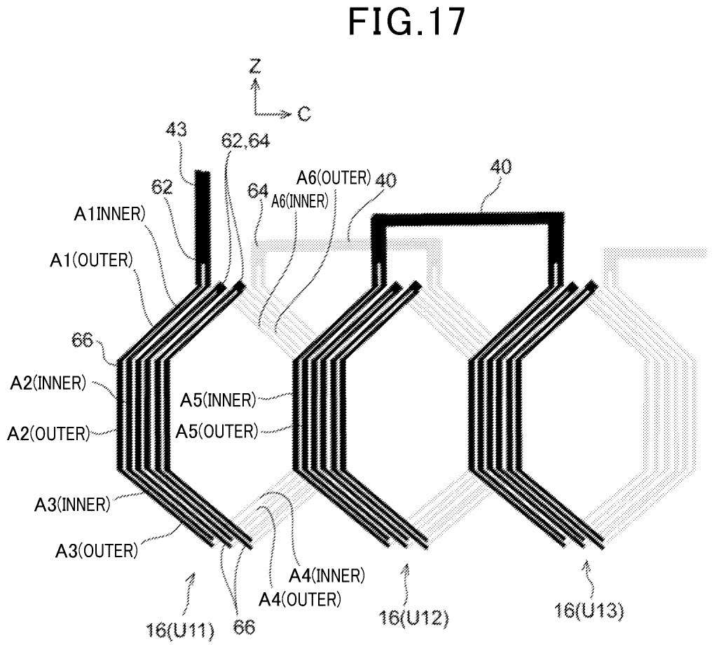

As shown in FIG. 17, in the present embodiment, in each of the coils 16, each of the first straight portions A1, B1 and C1, the second straight portions A2, B2 and C2, the third straight portions A3, B3 and C3, the fourth straight portions A4, B4 and C4, the fifth straight portions A5, B5 and C5, and the sixth straight portions A6, B6 and C6 is divided into two parts in a direction perpendicular to the extending direction of the straight portion. In the following explanation, that part of the first straight portion A1 which is located on the inner side in the coil 16 will be referred to as the “first straight portion A1 (inner)”; and that part of the first straight portion A1 which is located on the outer side in the coil 16 will be referred to as the “first straight portion A1 (outer)”. Similarly, each of the first straight portion B1, the first straight portion C1, the second straight portion A2, the second straight portion B2, the second straight portion C2, the third straight portion A3, the third straight portion B3, the third straight portion C3, the fourth straight portion A4, the fourth straight portion B4, the fourth straight portion C4, the fifth straight portion A5, the fifth straight portion B5, the fifth straight portion C5, the sixth straight portion A6, the sixth straight portion B6 and the sixth straight portion C6 will be explained with the denotation (inner) or (outer) added to the end of the reference sign designating the straight portion. It should be noted that in consideration of the ease of viewing the drawings, the denotation (inner) or (outer) is omitted from some of the reference sings designating the straight portions in the drawings.

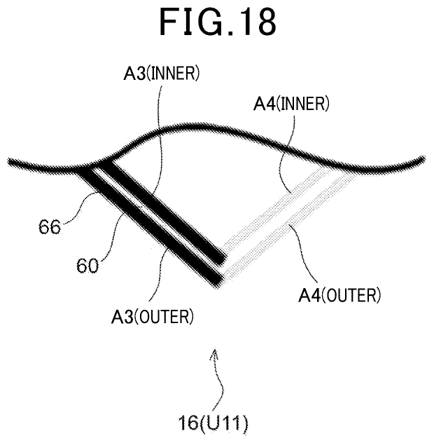

As shown in FIG. 17, the first straight portion A1 (inner) and the first straight portion A1 (outer) are separated by a slit 60 (see FIG. 18) formed therebetween and extend parallel to each other.

Similarly, the second straight portion A2 (inner) and the second straight portion A2 (outer) are separated by the slit 60 formed therebetween and extend parallel to each other. Moreover, the second straight portion A2 (inner) and the second straight portion A2 (outer) are connected respectively with the first straight portion A1 (inner) and the first straight portion A1 (outer).

The third straight portion A3 (inner) and the third straight portion A3 (outer) are separated by the slit 60 formed therebetween and extend parallel to each other. Moreover, the third straight portion A3 (inner) and the third straight portion A3 (outer) are connected respectively with the second straight portion A2 (inner) and the second straight portion A2 (outer).

The fourth straight portion A4 (inner) and the fourth straight portion A4 (outer) are separated by the slit 60 formed therebetween and extend parallel to each other. Moreover, as shown in FIG. 18, the fourth straight portion A4 (inner) and the fourth straight portion A4 (outer) are connected respectively with the third straight portion A3 (inner) and the third straight portion A3 (outer).

As shown in FIG. 17, the fifth straight portion A5 (inner) and the fifth straight portion A5 (outer) are separated by the slit 60 formed therebetween and extend parallel to each other. Moreover, the fifth straight portion A5 (inner) and the fifth straight portion A5 (outer) are connected respectively with the fourth straight portion A4 (inner) and the fourth straight portion A4 (outer).

The sixth straight portion A6 (inner) and the sixth straight portion A6 (outer) are separated by the slit 60 formed therebetween and extend parallel to each other. Moreover, the sixth straight portion A6 (inner) and the sixth straight portion A6 (outer) are connected respectively with the fifth straight portion A5 (inner) and the fifth straight portion A5 (outer).

The first straight portion B1 (inner), the first straight portion B1 (outer), the second straight portion B2 (inner), the second straight portion B2 (outer), the third straight portion B3 (inner), the third straight portion B3 (outer), the fourth straight portion B4 (inner), the fourth straight portion B4 (outer), the fifth straight portion B5 (inner), the fifth straight portion B5 (outer), the sixth straight portion B6 (inner) and the sixth straight portion B6 (outer) are configured in the same manner as the first straight portion A1 (inner), the first straight portion A1 (outer), the second straight portion A2 (inner), the second straight portion A2 (outer), the third straight portion A3 (inner), the third straight portion A3 (outer), the fourth straight portion A4 (inner), the fourth straight portion A4 (outer), the fifth straight portion A5 (inner), the fifth straight portion A5 (outer), the sixth straight portion A6 (inner) and the sixth straight portion A6 (outer). Moreover, the first straight portion C1 (inner), the first straight portion C1 (outer), the second straight portion C2 (inner), the second straight portion C2 (outer), the third straight portion C3 (inner), the third straight portion C3 (outer), the fourth straight portion C4 (inner), the fourth straight portion C4 (outer), the fifth straight portion C5 (inner), the fifth straight portion C5 (outer), the sixth straight portion C6 (inner) and the sixth straight portion C6 (outer) are also configured in the same manner as the first straight portion A1 (inner), the first straight portion A1 (outer), the second straight portion A2 (inner), the second straight portion A2 (outer), the third straight portion A3 (inner), the third straight portion A3 (outer), the fourth straight portion A4 (inner), the fourth straight portion A4 (outer), the fifth straight portion A5 (inner), the fifth straight portion A5 (outer), the sixth straight portion A6 (inner) and the sixth straight portion A6 (outer). In addition, the coils 16 (U21 to U83, V11 to V83, and W11 to W83) not shown in FIG. 17 have the same configuration as the coils 16 (U11 to U13) shown in FIG. 17.

An end of the first straight portion A1 (inner) on a side not connected to the second straight portion A2 (inner) and an end of the first straight portion A1 (outer) on a side not connected to the second straight portion A2 (outer) are connected with each other via a first connection portion 62. The first connection portion 62 may be constituted, for example, of part of a corresponding one of the connection portions 43. On the other hand, an end of the sixth straight portion A6 (inner) on a side not connected to the fifth straight portion A5 (inner) and an end of the sixth straight portion A6 (outer) on a side not connected to the fifth straight portion A5 (outer) are connected with each other via a second connection portion 64. The second connection portion 64 may be constituted, for example, of a portion where the sixth straight portion A6 (inner) and the sixth straight portion A6 (outer) are joined integrally with each other or of a via straddling the sixth straight portion A6 (inner) and the sixth straight portion A6 (outer) mounted to the band member 34 (see FIG. 7). Consequently, a closed circuit 66 is formed which has two paths connected with each other by the first connection portion 62 and the second connection portion 64; one of the two paths includes the first straight portion A1 (outer), the second straight portion A2 (outer), the third straight portion A3 (outer), the fourth straight portion A4 (outer), the fifth straight portion A5 (outer) and the sixth straight portion A6 (outer), whereas the other of the two paths includes the first straight portion A1 (inner), the second straight portion A2 (inner), the third straight portion A3 (inner), the fourth straight portion A4 (inner), the fifth straight portion A5 (inner) and the sixth straight portion A6 (inner).

An end of the first straight portion B1 (inner) on a side not connected to the second straight portion B2 (inner) and an end of the first straight portion B1 (outer) on a side not connected to the second straight portion B2 (outer) are connected with each other via a first connection portion 62. The first connection portion 62 may be constituted, for example, of a portion where the first straight portion B1 (inner) and the first straight portion B1 (outer) are joined integrally with each other or of a via straddling the first straight portion B1 (inner) and the first straight portion B1 (outer) mounted to the band member 34 (see FIG. 7). On the other hand, an end of the sixth straight portion B6 (inner) on a side not connected to the fifth straight portion B5 (inner) and an end of the sixth straight portion B6 (outer) on a side not connected to the fifth straight portion B5 (outer) are connected with each other via a second connection portion 64. The second connection portion 64 may be constituted, for example, of a portion where the sixth straight portion B6 (inner) and the sixth straight portion B6 (outer) are joined integrally with each other or of a via straddling the sixth straight portion B6 (inner) and the sixth straight portion B6 (outer) mounted to the band member 34 (see FIG. 7). Consequently, a closed circuit 66 is formed which has two paths connected with each other by the first connection portion 62 and the second connection portion 64; one of the two paths includes the first straight portion B1 (outer), the second straight portion B2 (outer), the third straight portion B3 (outer), the fourth straight portion B4 (outer), the fifth straight portion B5 (outer) and the sixth straight portion B6 (outer), whereas the other of the two paths includes the first straight portion B1 (inner), the second straight portion B2 (inner), the third straight portion B3 (inner), the fourth straight portion B4 (inner), the fifth straight portion B5 (inner) and the sixth straight portion B6 (inner).

An end of the first straight portion C1 (inner) on a side not connected to the second straight portion C2 (inner) and an end of the first straight portion C1 (outer) on a side not connected to the second straight portion C2 (outer) are connected with each other via a first connection portion 62. The first connection portion 62 may be constituted, for example, of a portion where the first straight portion C1 (inner) and the first straight portion C1 (outer) are joined integrally with each other or of a via straddling the first straight portion C1 (inner) and the first straight portion C1 (outer) mounted to the band member 34 (see FIG. 7). On the other hand, an end of the sixth straight portion C6 (inner) on a side not connected to the fifth straight portion C5 (inner) and an end of the sixth straight portion C6 (outer) on a side not connected to the fifth straight portion C5 (outer) are connected with each other via a second connection portion 64. The second connection portion 64 may be constituted, for example, of part of the connection pattern section 40. Consequently, a closed circuit 66 is formed which has two paths connected with each other by the first connection portion 62 and the second connection portion 64; one of the two paths includes the first straight portion C1 (outer), the second straight portion C2 (outer), the third straight portion C3 (outer), the fourth straight portion C4 (outer), the fifth straight portion C5 (outer) and the sixth straight portion C6 (outer), whereas the other of the two paths includes the first straight portion C1 (inner), the second straight portion C2 (inner), the third straight portion C3 (inner), the fourth straight portion C4 (inner), the fifth straight portion C5 (inner) and the sixth straight portion C6 (inner).

As described above, in the present embodiment, each of the coils 16 has the three closed circuits 66 formed respectively in the first, second and third turns thereof. In other words, to each turn of each coil 16, there is formed one closed circuit 66.

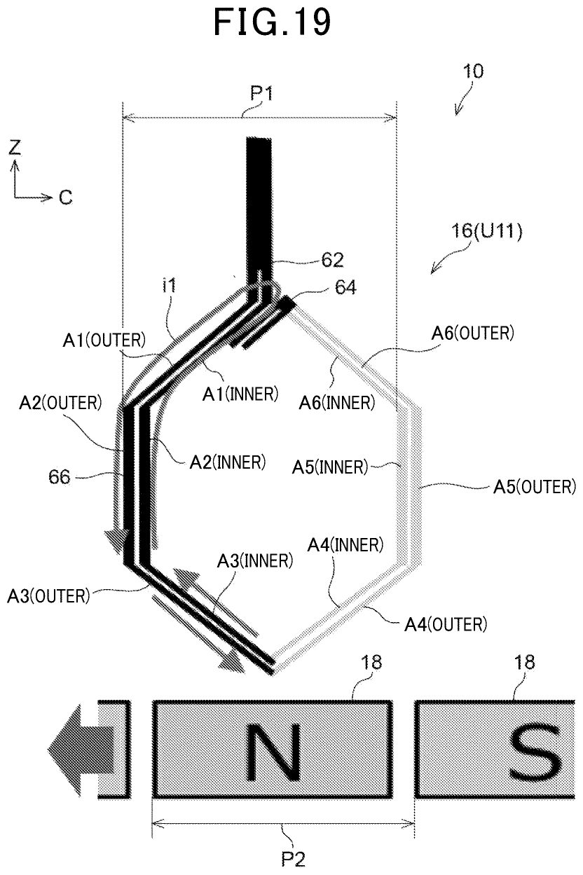

FIG. 19 schematically shows a part of one of the coils 16 which forms the first turn of the coil 16 and the magnets 18 that constitute part of the rotor 12. Here, the circumferential pitch from the second straight portion A2 (outer) to the fifth straight portion A5 (inner) is denoted by P1 (deg); and the circumferential pitch from an end of an N-pole magnet 18 on one side in the rotation direction to an end of an S-pole magnet 18, which arranged adjacent to the N-pole magnet 18, on the aforementioned side in the rotation direction is defined as P2 (deg). In the present embodiment, the circumferential pitches P1 and P2 are set to be equal to each other. In addition, the circumferential pitch P1 from the second straight portion B2 (outer) to the fifth straight portion B5 (inner) and the circumferential pitch P1 from the second straight portion C2 (outer) to the fifth straight portion C5 (inner) are also set to be equal to the circumferential pitch as P2.

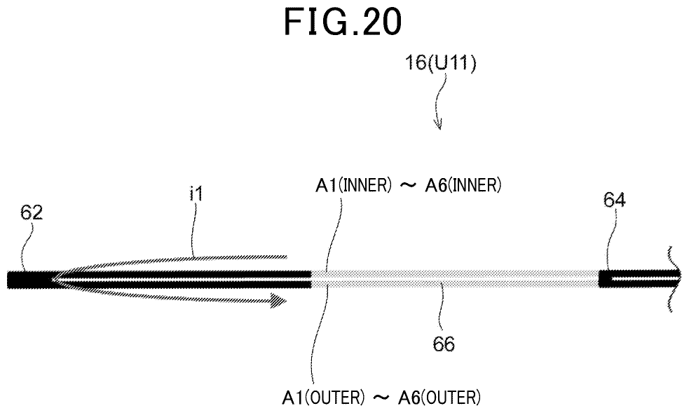

In FIGS. 19 and 20, induced current, which is induced in the coil 16 due to the N-pole magnet 18 passing over the coil 16, is indicated by an arrow i1. The induced current i1 flows through the third straight portion A3 (inner), the second straight portion A2 (inner), the first straight portion A1 (inner), the first connection portion 62, the first straight portion A1 (outer), the second straight portion A2 (outer) and the third straight portion A3 (outer) in this order.

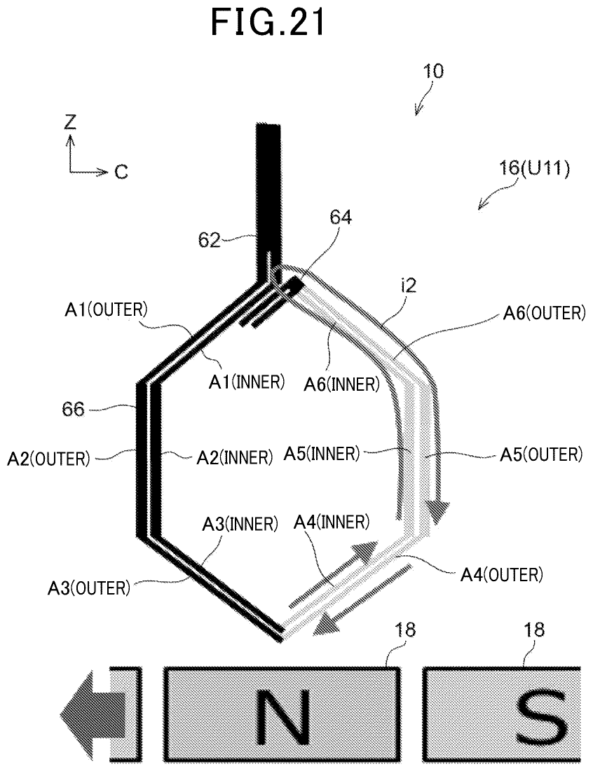

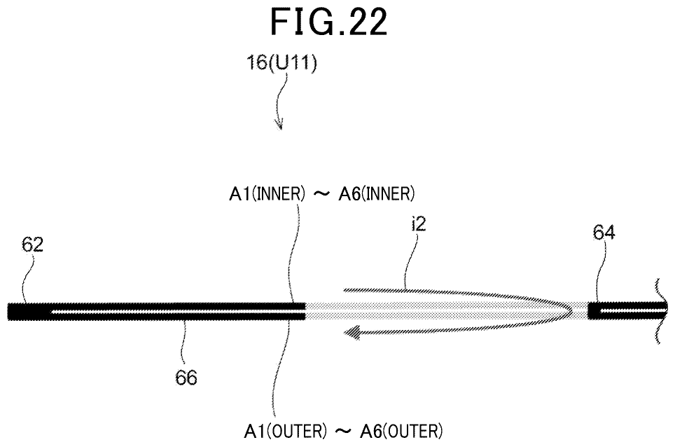

In FIGS. 21 and 22, induced current, which is induced in the coil 16 due to the S-pole magnet 18 passing over the coil 16, is indicated by an arrow i2. The induced current i2 flows through the fourth straight portion A4 (inner), the fifth straight portion A5 (inner), the sixth straight portion A6 (inner), the second connection portion 64, the sixth straight portion A6 (outer), the fifth straight portion A5 (outer) and the fourth straight portion A4 (outer) in this order.

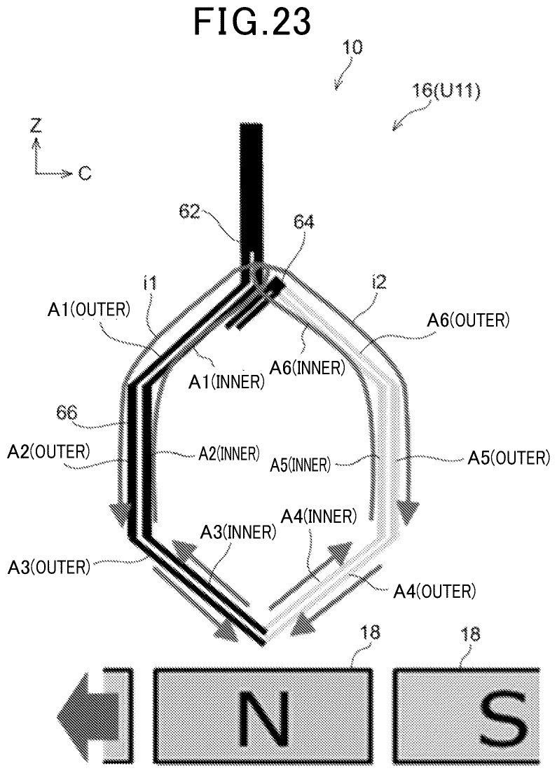

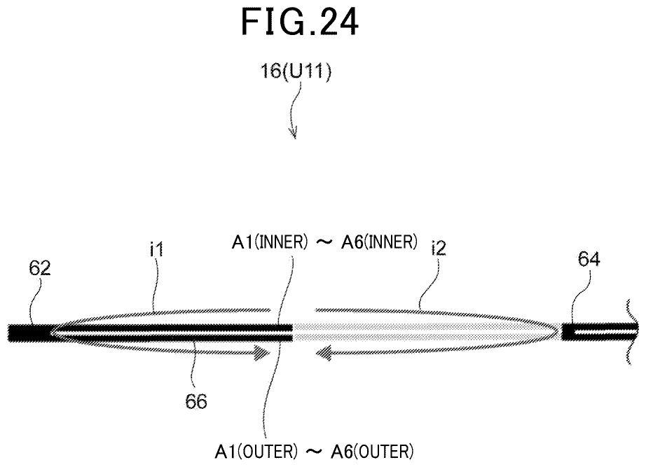

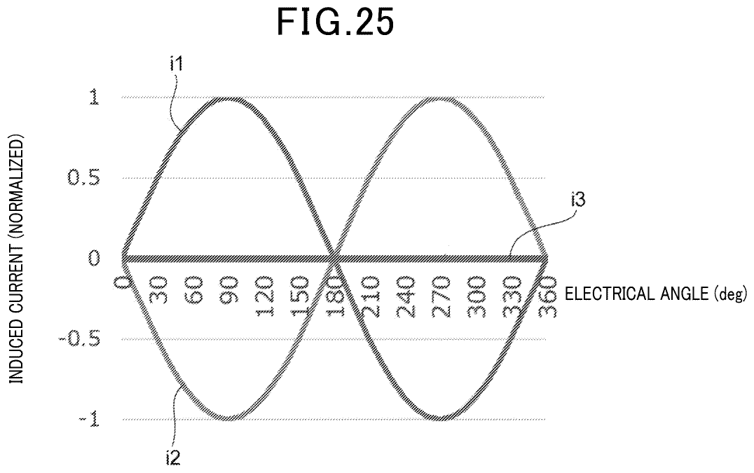

Consequently, as shown in FIGS. 23 and 24, the induced currents i1 and i2, which are induced in the coil 16, flow in such a manner as to cancel each other out. That is, the electromotive force acting to cause the induced current i1 to flow in the coil 16 and the electromotive force acting to cause the induced current i2 to flow in the coil 16 cancel each other out. In the present embodiment, as shown in FIG. 25, when the rotor 12 rotates 360 degrees in electrical angle, the induced currents i1 and i2 are cancelled out by each other; thus, the resultant current i3 of the induced currents flowing in the coil 16 becomes almost zero.

As described above, in the motor 10 according to the present embodiment, by dividing each of the straight portions of the coils 16 into two parts, it becomes possible to reduce the area of each of the coils 16 facing the magnets 18, thereby reducing the local induced currents that are induced in the coils 16 due to the magnets 18 passing over the coils 16. Moreover, it also becomes possible to make the resultant current i3 of the induced currents, which are induced in the closed circuits 66 of each of the coils 16 due to the magnets 18 passing over the coil 16, almost zero; the closed circuits 66 are formed by dividing each of the straight portions of the coils 16 into two parts. Consequently, it becomes possible to suppress loss caused by the induced currents. As a result, it becomes possible to achieve improvement in the torque of the motor 10 while suppressing increase in the size of the motor 10. Furthermore, by suppressing loss caused by the induced currents, it also becomes possible to suppress generation of heat in the coils 16. Consequently, it becomes possible to achieve low heat generation of the motor 10.

In the present embodiment, each of the coils 16 has the three closed circuits 66 formed respectively in the first, second and third turns thereof. Consequently, it becomes possible to have the induced currents canceled out by each other in each of the turns. Moreover, it also becomes possible to connect the ends of the coils 16 on one side in parallel with each other, thereby facilitating connection between the coils 16 and connection of the coils 16 to the neutral point.

### Second Embodiment

Next, a motor 48 according to the second embodiment will be described. It should be noted that: members and parts of the motor 48 according to the second embodiment corresponding to those of the motor 10 according to the first embodiment are designated by the same reference signs as the corresponding members and parts of the motor 10 according to the first embodiment; and description of these parts and members will be omitted hereinafter.

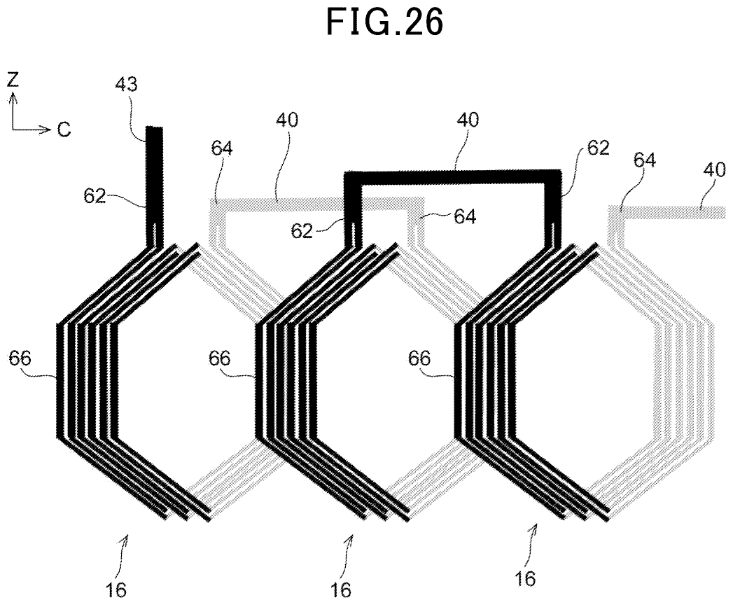

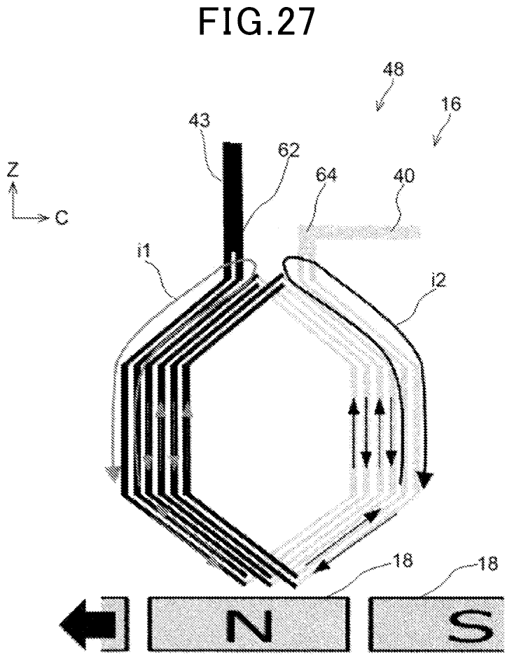

As shown in FIGS. 26, 27 and 28, the motor 48 according to the present embodiment is configured identically to the motor 10 according to the first embodiment described above, except that each of the coils 16 has a single closed circuit 66 formed therein in the motor 48 according to the present embodiment.

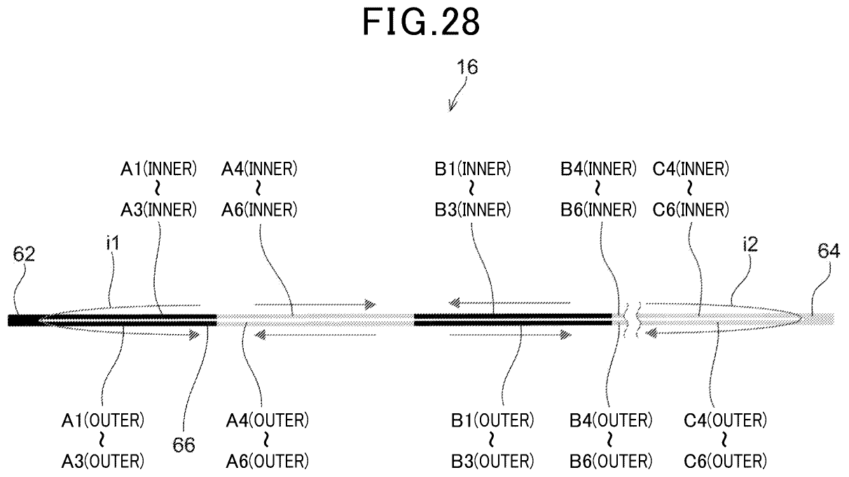

Specifically, as shown in FIGS. 26 and 28, in the motor 48 according to the present embodiment, to each of the coils 16, there is formed one closed circuit 66 which has two paths connected with each other by a first connection portion 62 and a second connection portion 64. One of the two paths includes the first straight portion A1 (outer), the second straight portion A2 (outer), the third straight portion A3 (outer), the fourth straight portion A4 (outer), the fifth straight portion A5 (outer), the sixth straight portion A6 (outer), the first straight portion B1 (outer), the second straight portion B2 (outer), the third straight portion B3 (outer), the fourth straight portion B4 (outer), the fifth straight portion B5 (outer), the sixth straight portion B6 (outer), the first straight portion C1 (outer), the second straight portion C2 (outer), the third straight portion C3 (outer), the fourth straight portion C4 (outer), the fifth straight portion C5 (outer) and the sixth straight portion C6 (outer). The other of the two paths includes the first straight portion A1 (inner), the second straight portion A2 (inner), the third straight portion A3 (inner), the fourth straight portion A4 (inner), the fifth straight portion A5 (inner), the sixth straight portion A6 (inner), the first straight portion B1 (inner), the second straight portion B2 (inner), the third straight portion B3 (inner), the fourth straight portion B4 (inner), the fifth straight portion B5 (inner), the sixth straight portion B6 (inner), the first straight portion C1 (inner), the second straight portion C2 (inner), the third straight portion C3 (inner), the fourth straight portion C4 (inner), the fifth straight portion C5 (inner) and the sixth straight portion C6 (inner).

Moreover, as shown in FIGS. 27 and 28, in the motor 48 according to the present embodiment, the induced currents i1 and i2, which are induced in each of the coils 16, flow in such a manner as to cancel each other out. Consequently, it becomes possible to suppress loss caused by the induced currents. As a result, it becomes possible to achieve improvement in the torque of the motor 48 while suppressing increase in the size of the motor 48.

Furthermore, in the motor 48 according to the present embodiment, to each of the coils 16, there is formed one closed circuit 66. Consequently, it becomes possible to have the induced currents canceled out by each other in each of the coils 16.

### Third Embodiment

Next, a motor according to the third embodiment will be described. It should be noted that: members and parts of the motor according to the third embodiment corresponding to those of the motor 10 according to the first embodiment are designated by the same reference signs as the corresponding members and parts of the motor 10 according to the first embodiment; and description of these parts and members will be omitted hereinafter.

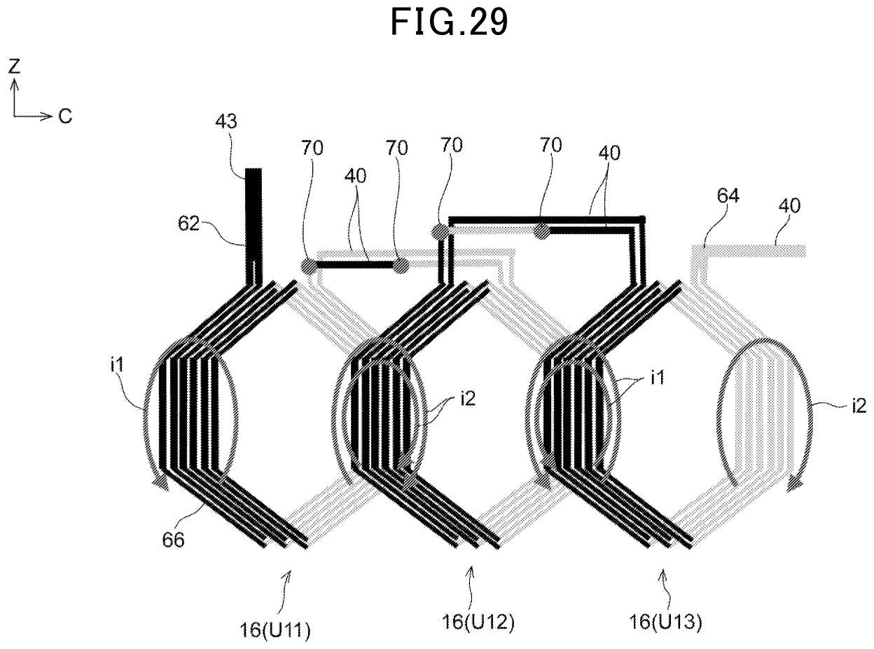

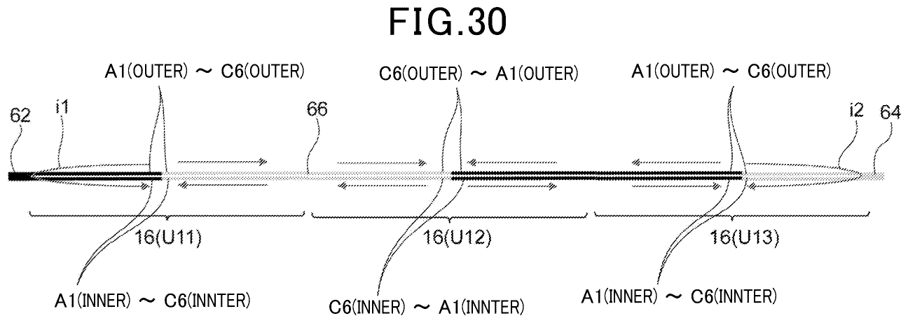

As shown in FIGS. 29 and 30, the motor according to the present embodiment is configured identically to the motor 10 according to the first embodiment described above, except that one closed circuit 66 is formed to three serially-connected coils 16 in the motor according to the present embodiment.

Specifically, in the motor according to the present embodiment, to three coils U11, U12 and U13 that are connected in series with each other, there is formed one closed circuit 66 which has two paths connected with each other by a first connection portion 62 and a second connection portion 64. One of the two paths includes: the first straight portion A1 (outer) to the sixth straight portion C6 (outer) of the first coil 16 (U11); the sixth straight portion C6 (outer) to the first straight portion A1 (outer) of the second coil 16 (U12); and the first straight portion A1 (outer) to the sixth straight portion C6 (outer) of the third coil 16 (U13). The other of the two paths includes: the first straight portion A1 (inner) to the sixth straight portion C6 (inner) of the first coil 16 (U11); the sixth straight portion C6 (inner) to the first straight portion A1 (inner) of the second coil 16 (U12); and the first straight portion A1 (inner) to the sixth straight portion C6 (inner) of the third coil 16 (U13). Moreover, although not shown in the drawings, closed circuits 66 are also formed respectively to serially-connected trios of the other coils 16 (U21 to U83, V11 to V83 and W11 to W83) in the same manner as the closed circuit 66 formed to the above-described three coils 16 (U11 to U13).

In addition, to connect the above-described three coils 16 in series with each other, portions of the connection pattern section 40 are suitably formed, through vias 70, on the first surface 34A and the second surface 34B of the band member 34 (see FIG. 7).

As shown in FIGS. 29 and 30, in the motor according to the present embodiment, the induced currents i1 and i2, which are induced in the coils 16, flow in such a manner as to cancel each other out. It should be noted that the double arrows in FIG. 29 respectively indicate the induced current flowing on the first surface 34A of the band member 34 and the induced current flowing on the second surface 34B of the band member 34. Consequently, it becomes possible to suppress loss caused by the induced currents. As a result, it becomes possible to achieve improvement in the torque of the motor while suppressing increase in the size of the motor.

Furthermore, in the motor according to the present embodiment, one closed circuit 66 is formed to a plurality of coils 16. Consequently, it becomes possible to have the induced currents canceled out by each other in units of a plurality of coils 16.

### Fourth Embodiment

Next, a motor according to the fourth embodiment will be described. It should be noted that: members and parts of the motor according to the fourth embodiment corresponding to those of the motor 10 according to the first embodiment are designated by the same reference signs as the corresponding members and parts of the motor 10 according to the first embodiment; and description of these parts and members will be omitted hereinafter.

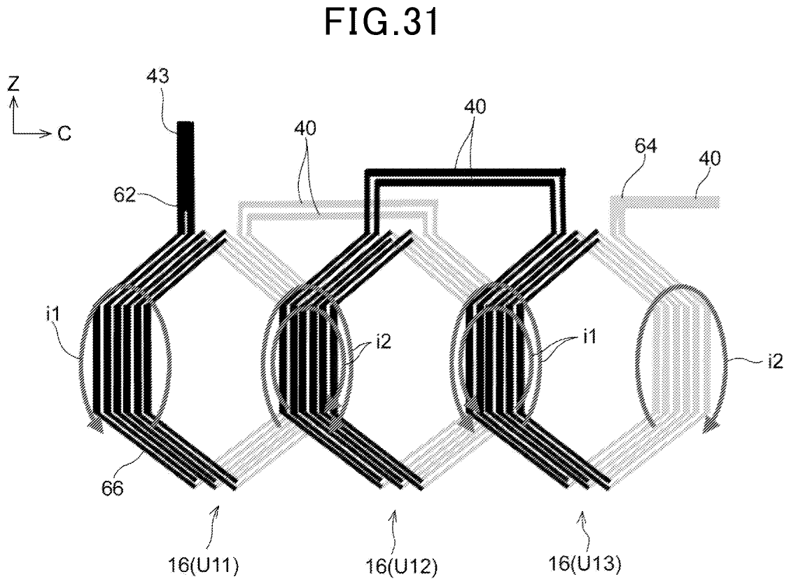

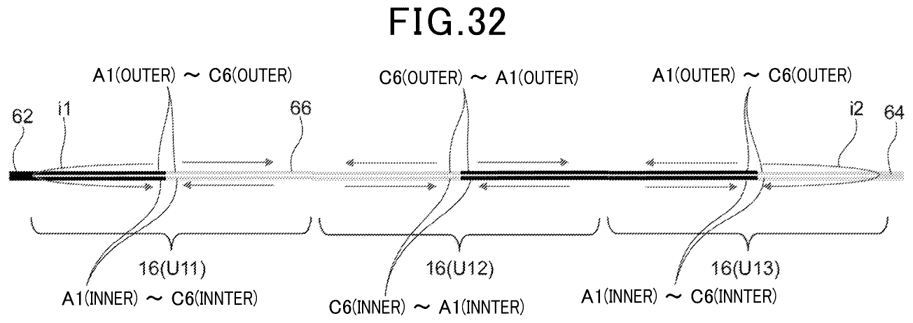

As shown in FIGS. 31 and 32, the motor according to the present embodiment is configured identically to the motor according to the third embodiment described above, except that the configuration of the connection pattern section 40 according to the present embodiment is different that according to the third embodiment.

As shown in FIG. 31, in the motor according to the present embodiment, the sixth straight portion C6 (outer) of the first coil 16 (U11) and the sixth straight portion C6 (inner) of the second coil 16 (U12) are connected with each other via the connection pattern section 40. On the other hand, the sixth straight portion C6 (inner) of the first coil 16 (U11) and the sixth straight portion C6 (outer) of the second coil 16 (U12) are connected with each other via the connection pattern section 40. Moreover, the first straight portion C1 (outer) of the second coil 16 (U12) and the first straight portion C1 (inner) of the third coil 16 (U13) are connected with each other via the connection pattern section 40. On the other hand, the first straight portion C1 (inner) of the second coil 16 (U12) and the first straight portion C1 (outer) of the third coil 16 (U13) are connected with each other via the connection pattern section 40. In addition, in the present embodiment, the connection pattern section 40 is configured to have no vias 70 (see FIG. 29).

As shown in FIGS. 31 and 32, in the motor according to the present embodiment, the induced currents i1 and i2, which are induced in the coils 16, flow in such a manner as to cancel each other out. Consequently, it becomes possible to suppress loss caused by the induced currents. As a result, it becomes possible to achieve improvement in the torque of the motor while suppressing increase in the size of the motor.

### Fifth Embodiment

Next, a motor 72 according to the fifth embodiment will be described. It should be noted that: members and parts of the motor 72 according to the fifth embodiment corresponding to those of the motor 10 according to the first embodiment are designated by the same reference signs as the corresponding members and parts of the motor 10 according to the first embodiment; and description of these parts and members will be omitted hereinafter.

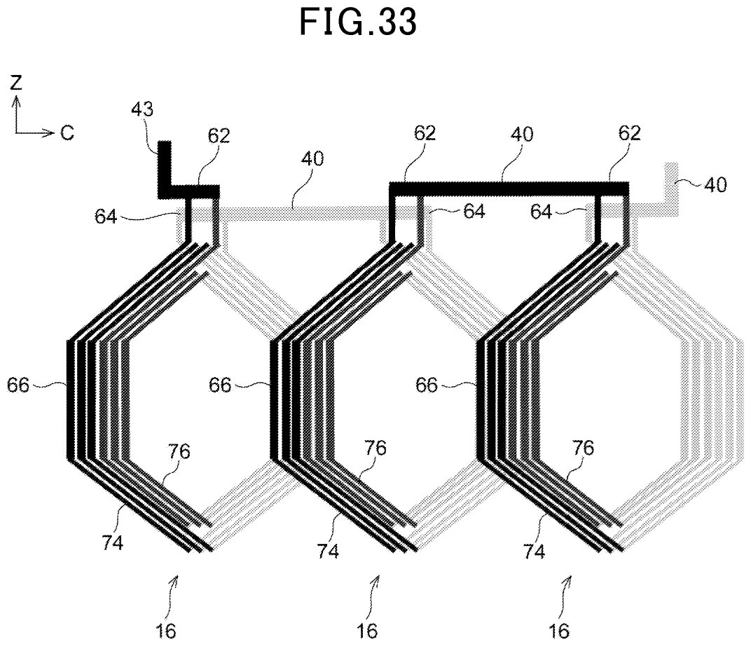

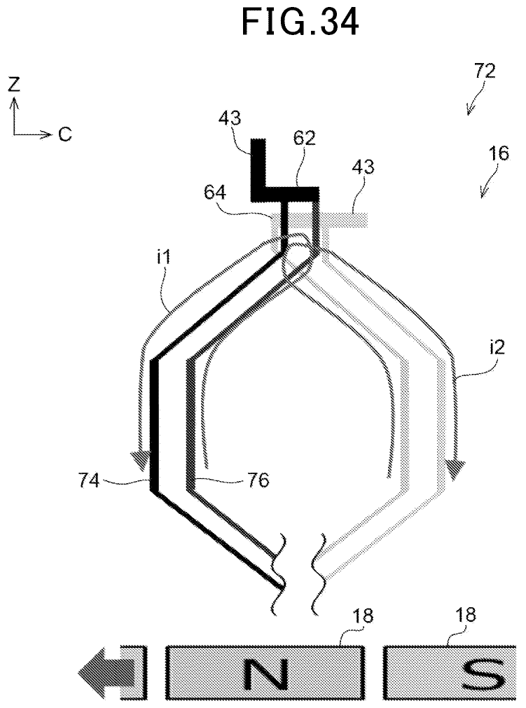

As shown in FIGS. 33 and 34, in the motor 72 according to the present embodiment, the first straight portion A1 (outer), the second straight portion A2 (outer), the third straight portion A3 (outer), the fourth straight portion A4 (outer), the fifth straight portion A5 (outer), the sixth straight portion A6 (outer), the first straight portion B1 (outer), the second straight portion B2 (outer), the third straight portion B3 (outer), the fourth straight portion B4 (outer), the fifth straight portion B5 (outer), the sixth straight portion B6 (outer), the first straight portion C1 (outer), the second straight portion C2 (outer), the third straight portion C3 (outer), the fourth straight portion C4 (outer), the fifth straight portion C5 (outer) and the sixth straight portion C6 (outer) are connected in parallel with the first straight portion A1 (inner), the second straight portion A2 (inner), the third straight portion A3 (inner), the fourth straight portion A4 (inner), the fifth straight portion A5 (inner), the sixth straight portion A6 (inner), the first straight portion B1 (inner), the second straight portion B2 (inner), the third straight portion B3 (inner), the fourth straight portion B4 (inner), the fifth straight portion B5 (inner), the sixth straight portion B6 (inner), the first straight portion C1 (inner), the second straight portion C2 (inner), the third straight portion C3 (inner), the fourth straight portion C4 (inner), the fifth straight portion C5 (inner) and the sixth straight portion C6 (inner).

Moreover, in the motor 72 according to the present embodiment, the first straight portion A1 (outer), the second straight portion A2 (outer), the third straight portion A3 (outer), the fourth straight portion A4 (outer), the fifth straight portion A5 (outer), the sixth straight portion A6 (outer), the first straight portion B1 (outer), the second straight portion B2 (outer), the third straight portion B3 (outer), the fourth straight portion B4 (outer), the fifth straight portion B5 (outer), the sixth straight portion B6 (outer), the first straight portion C1 (outer), the second straight portion C2 (outer), the third straight portion C3 (outer), the fourth straight portion C4 (outer), the fifth straight portion C5 (outer) and the sixth straight portion C6 (outer) together constitute an outer coil 74.

On the other hand, the first straight portion A1 (inner), the second straight portion A2 (inner), the third straight portion A3 (inner), the fourth straight portion A4 (inner), the fifth straight portion A5 (inner), the sixth straight portion A6 (inner), the first straight portion B1 (inner), the second straight portion B2 (inner), the third straight portion B3 (inner), the fourth straight portion B4 (inner), the fifth straight portion B5 (inner), the sixth straight portion B6 (inner), the first straight portion C1 (inner), the second straight portion C2 (inner), the third straight portion C3 (inner), the fourth straight portion C4 (inner), the fifth straight portion C5 (inner) and the sixth straight portion C6 (inner) together constitute an inner coil 76.

In addition, the other configurations of the motor 72 according to the present embodiment are identical to those of the motor 48 according to the second embodiment described above.

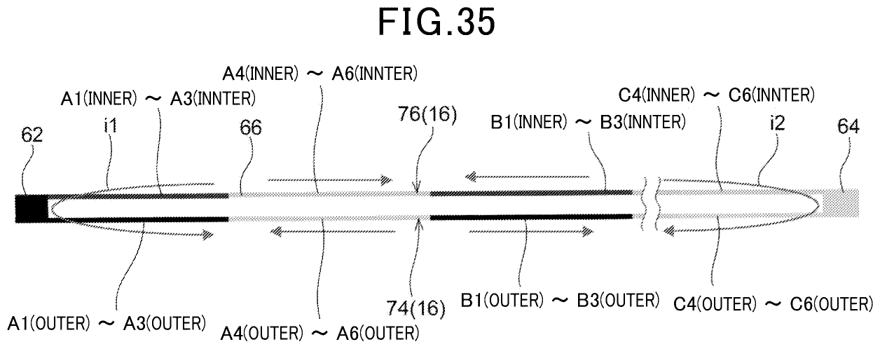

As shown in FIGS. 33, 34 and 35, in the motor 72 according to the present embodiment, the induced currents i1 and i2, which are induced in the outer coil 74 and the inner coil 76, flow in such a manner as to cancel each other out. Consequently, it becomes possible to suppress loss caused by the induced currents. As a result, it becomes possible to achieve improvement in the torque of the motor 72 while suppressing increase in the size of the motor 72.

Furthermore, in the motor 72 according to the present embodiment, one closed circuit 66 is formed to each pair of an outer coil 74 and an inner coil 76. Consequently, it becomes possible to have the induced currents canceled out by each other in each pair of an outer coil 74 and an inner coil 76.

### Sixth Embodiment

Next, a motor according to the sixth embodiment will be described. It should be noted that: members and parts of the motor according to the sixth embodiment corresponding to those of the motor 10 according to the first embodiment are designated by the same reference signs as the corresponding members and parts of the motor 10 according to the first embodiment; and description of these parts and members will be omitted hereinafter.

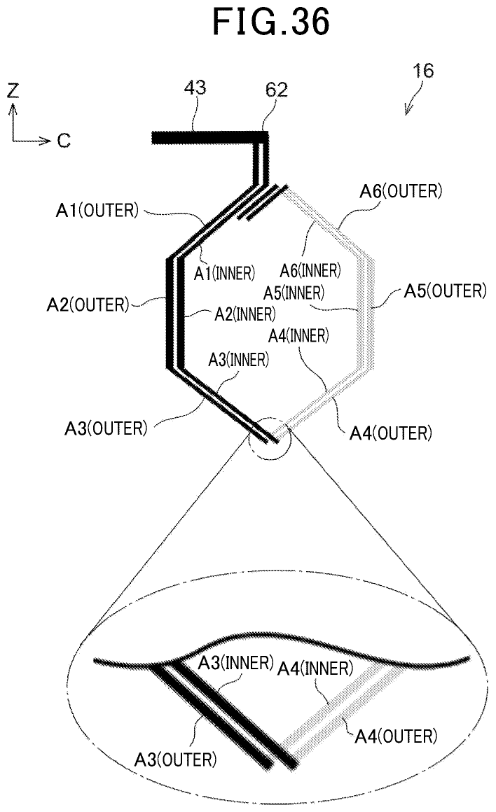

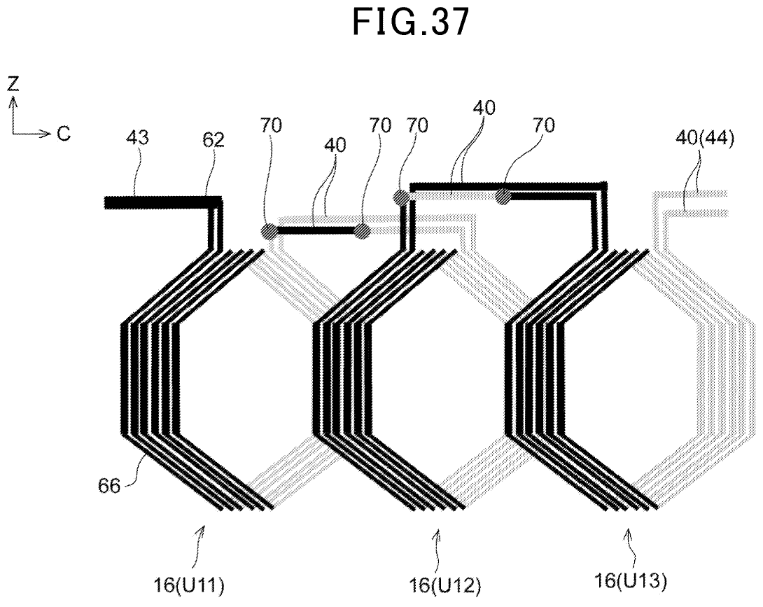

As shown in FIG. 36, in each of the coils 16 of the motor according to the present embodiment, the fourth straight portion A4 (inner) and the fourth straight portion A4 (outer) are connected respectively with the third straight portion A3 (outer) and the third straight portion A3 (inner). Moreover, the first straight portion B1 (inner) and the first straight portion B1 (outer) are connected respectively with the sixth straight portion A6 (outer) and the sixth straight portion A6 (inner). Similarly, as shown in FIG. 37, the fourth straight portion B4 (inner) and the fourth straight portion B4 (outer) are connected respectively with the third straight portion A3 (outer) and the third straight portion A3 (inner). Moreover, the first straight portion C1 (inner) and the first straight portion C1 (outer) are connected respectively with the sixth straight portion B6 (outer) and the sixth straight portion B6 (inner). That is, in each of the coils 16 of the motor according to the present embodiment, the relationship of (inner) and (outer) is reversed at those parts in the path of the coil 16 where the coil 16 is folded back from the first side to the second side in the axial direction; and the relationship of (inner) and (outer) is reversed also at those parts in the path of the coil 16 where the coil 16 is folded back from the second side to the first side in the axial direction.

Moreover, as shown in FIGS. 36 and 37, in each of the coils 16 of the motor according to the present embodiment, the axial positions of those parts in the path of the coil 16 where the coil 16 is folded back from the first side to the second side in the axial direction are set to be the same as each other; and the axial positions of those parts in the path of the coil 16 where the coil 16 is folded back from the second side to the first side in the axial direction are set to be the same as each other.

Specifically, the axial position of that part in the path of the coil 16 where the coil 16 is folded back from the third straight portion A3 (outer) to the fourth straight portion A4 (inner), the axial position of that part in the path of the coil 16 where the coil 16 is folded back from the third straight portion A3 (inner) to the fourth straight portion A4 (outer), the axial position of that part in the path of the coil 16 where the coil 16 is folded back from the third straight portion B3 (outer) to the fourth straight portion B4 (inner), the axial position of that part in the path of the coil 16 where the coil 16 is folded back from the third straight portion B3 (inner) to the fourth straight portion B4 (outer), the axial position of that part in the path of the coil 16 where the coil 16 is folded back from the third straight portion C3 (outer) to the fourth straight portion C4 (inner), and the axial position of that part in the path of the coil 16 where the coil 16 is folded back from the third straight portion C3 (inner) to the fourth straight portion C4 (outer) are set to be the same as each other.

On the other hand, the axial position of that part in the path of the coil 16 where the coil 16 is folded back from the sixth straight portion A6 (outer) to the first straight portion B1 (inner), the axial position of that part in the path of the coil 16 where the coil 16 is folded back from the sixth straight portion A6 (inner) to the first straight portion B1 (outer), the axial position of that part in the path of the coil 16 where the coil 16 is folded back from the sixth straight portion B6 (outer) to the first straight portion C1 (inner), and the axial position of that part in the path of the coil 16 where the coil 16 is folded back from the sixth straight portion B6 (inner) to the first straight portion C1 (outer) are set to be the same as each other.

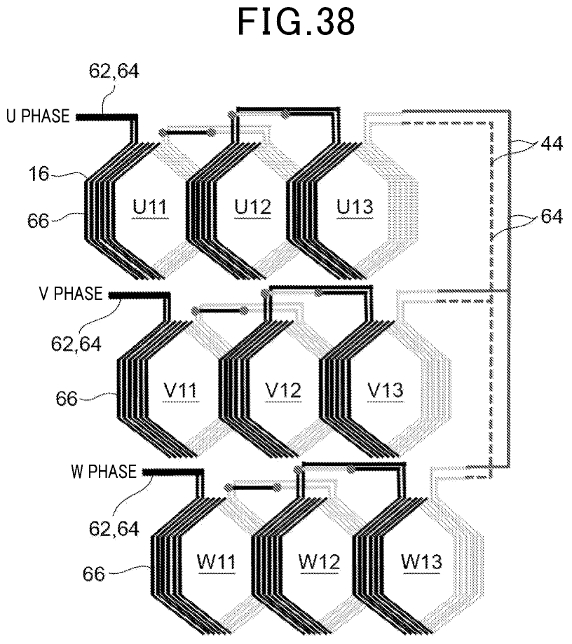

As shown in FIG. 38, the sixth straight portion C6 (inner) of the U-phase coil 16 (U13), the sixth straight portion C6 (inner) of the V-phase coil 16 (V13) and the sixth straight portion C6 (inner) of the W-phase coil 16 (W13) are connected with each other by the neutral point 44. On the other hand, the sixth straight portion C6 (outer) of the U-phase coil 16 (U13), the sixth straight portion C6 (outer) of the V-phase coil 16 (V13) and the sixth straight portion C6 (outer) of the W-phase coil 16 (W13) are connected with each other by the neutral point 44.

With the above configuration, as shown in FIG. 38, a closed circuit 66 is formed which has two paths connected with each other by a U-phase first connection portion 62, a V-phase first connection portion 62 and a W-phase first connection portion 62. One of the two paths includes: the first straight portion A1 (outer) to the sixth straight portion C6 (inner) of the U-phase coil 16 (U11); the sixth straight portion C6 (inner) to the first straight portion A1 (outer) of the U-phase coil 16 (U12); and the first straight portion A1 (outer) to the sixth straight portion C6 (inner) of the U-phase coil 16 (U13). The other of the two paths includes: the first straight portion A1 (inner) to the sixth straight portion C6 (outer) of the U-phase coil 16 (U11); the sixth straight portion C6 (outer) to the first straight portion A1 (inner) of the U-phase coil 16 (U12); and the first straight portion A1 (inner) to the sixth straight portion C6 (outer) of the U-phase coil 16 (U13). That is, from the viewpoint of the U-phase, the V-phase first connection portion 62 and the W-phase first connection portion 62 function as a U-phase second connection portion 64.

Moreover, another closed circuit 66 is formed which has two paths connected with each other by the V-phase first connection portion 62, the U-phase first connection portion 62 and the W-phase first connection portion 62. One of the two paths includes: the first straight portion A1 (outer) to the sixth straight portion C6 (inner) of the V-phase coil 16 (V11); the sixth straight portion C6 (inner) to the first straight portion A1 (outer) of the V-phase coil 16 (V12); and the first straight portion A1 (outer) to the sixth straight portion C6 (inner) of the V-phase coil 16 (V13). The other of the two paths includes: the first straight portion A1 (inner) to the sixth straight portion C6 (outer) of the V-phase coil 16 (V11); the sixth straight portion C6 (outer) to the first straight portion A1 (inner) of the V-phase coil 16 (V12); and the first straight portion A1 (inner) to the sixth straight portion C6 (outer) of the V-phase coil 16 (V13). That is, from the viewpoint of the V-phase, the U-phase first connection portion 62 and the W-phase first connection portion 62 function as a V-phase second connection portion 64.

Furthermore, yet another closed circuit 66 is formed which has two paths connected with each other by the W-phase first connection portion 62, the U-phase first connection portion 62 and the V-phase first connection portion 62. One of the two paths includes: the first straight portion A1 (outer) to the sixth straight portion C6 (inner) of the W-phase coil 16 (W11); the sixth straight portion C6 (inner) to the first straight portion A1 (outer) of the W-phase coil 16 (W12); and the first straight portion A1 (outer) to the sixth straight portion C6 (inner) of the W-phase coil 16 (W13). The other of the two paths includes: the first straight portion A1 (inner) to the sixth straight portion C6 (outer) of the W-phase coil 16 (W11); the sixth straight portion C6 (outer) to the first straight portion A1 (inner) of the W-phase coil 16 (W12); and the first straight portion A1 (inner) to the sixth straight portion C6 (outer) of the W-phase coil 16 (W13). That is, from the viewpoint of the W-phase, the U-phase first connection portion 62 and the V-phase first connection portion 62 function as a W-phase second connection portion 64.

Moreover, although not shown in the drawings, closed circuits 66 are also formed to the other coils 16 (U21 to U83, V21 to V83, and W21 to W83) in the same manner as the closed circuits 66 formed to the above-described coils 16 (U11 to U13, V11 to V13, and W11 to W13).

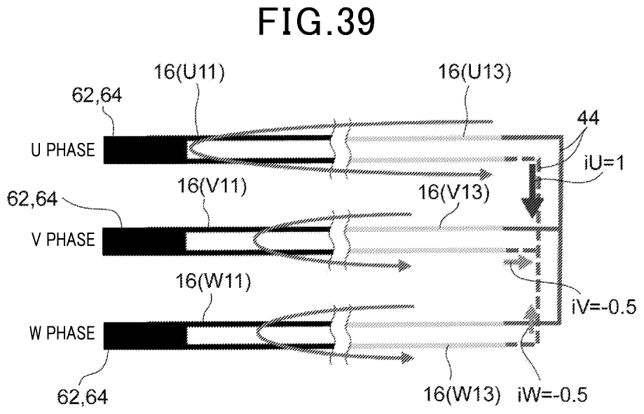

As shown in FIG. 39, in the above-described motor according to the present embodiment, the induced current iU that is induced in the U-phase coils 16 can be canceled out by the induced current iV that is induced in the V-phase coils 16 and the induced current iW that is induced in the W-phase coils 16. For example, suppose the induced current iU that is induced in the U-phase coils 16 to be 1 and each of the induced current iV that is induced in the V-phase coils 16 and the induced current iW that is induced in the W-phase coils 16 to be −0.5. Then, the induced current iU that is induced in the U-phase coils 16 would be canceled out by the induced current iV that is induced in the V-phase coils 16 and the induced current iW that is induced in the W-phase coils 16. In this manner, in the motor according to the present embodiment, the resultant current i3 of the induced currents flowing in the coils 16 of each phase becomes almost zero. Consequently, it becomes possible to suppress loss caused by the induced currents. As a result, it becomes possible to achieve improvement in the torque of the motor while suppressing increase in the size of the motor.

Moreover, as shown in FIGS. 36 and 37, in the motor according to the present embodiment, the axial positions of those parts in the paths of the coils 16 where the coils 16 are folded back from the first side to the second side in the axial direction are set to be the same as each other; and the axial positions of those parts in the paths of the coils 16 where the coils 16 are folded back from the second side to the first side in the axial direction are set to be the same as each other. Consequently, it becomes possible to suppress increase in the axial dimension of the coil end portions 38. As a result, it becomes possible to suppress increase in the axial dimension of the entire coils 16.

### Seventh Embodiment

Next, a motor according to the seventh embodiment will be described. It should be noted that: members and parts of the motor according to the seventh embodiment corresponding to those of the motor 10 according to the first embodiment are designated by the same reference signs as the corresponding members and parts of the motor 10 according to the first embodiment; and description of these parts and members will be omitted hereinafter.

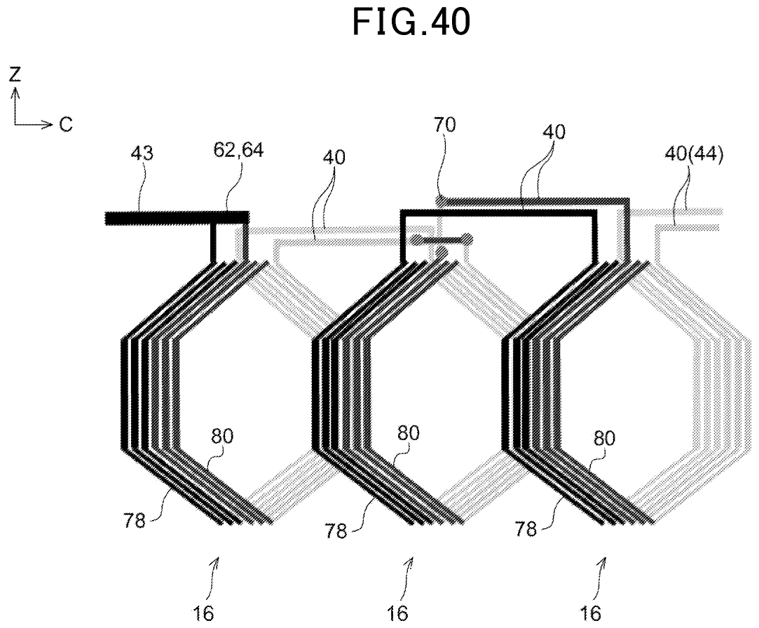

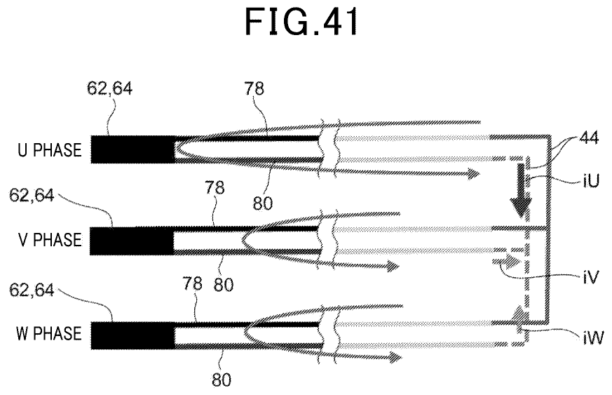

As shown in FIGS. 40 and 41, the motor according to the present embodiment has a configuration that is a combination of the configuration of the motor 72 according to the fifth embodiment and the configuration of the motor according to the sixth embodiment. Specifically, in the motor according to the present embodiment, a first coil 78 and a second coil 80, which correspond to the outer coil 74 and the inner coil 76 in the motor 72 according to the fifth embodiment, are identical in shape and dimensions to each other. Moreover, the second coil 80 is offset to the first side in the circumferential direction from the first coil 78.

In the above-described motor according to the present embodiment, the induced current iU that is induced in the U-phase first coil 78 and the U-phase second coil 80 can be canceled out by the induced current iV that is induced in the V-phase first coil 78 and the V-phase second coil 80 and the induced current iW that is induced in the W-phase first coil 78 and the W-phase second coil 80. Consequently, it becomes possible to suppress loss caused by the induced currents. As a result, it becomes possible to achieve improvement in the torque of the motor while suppressing increase in the size of the motor.

### Eighth Embodiment

Next, a motor 82 according to the eighth embodiment will be described. It should be noted that: members and parts of the motor 82 according to the eighth embodiment corresponding to those of the motor 10 according to the first embodiment are designated by the same reference signs as the corresponding members and parts of the motor 10 according to the first embodiment; and description of these parts and members will be omitted hereinafter.

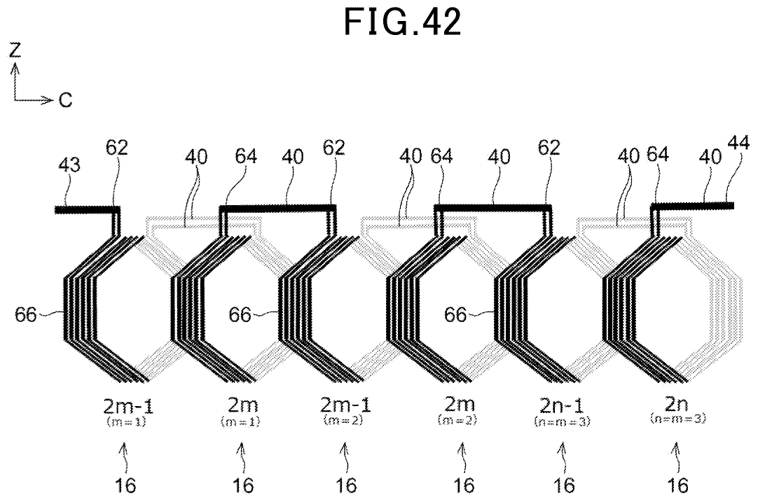

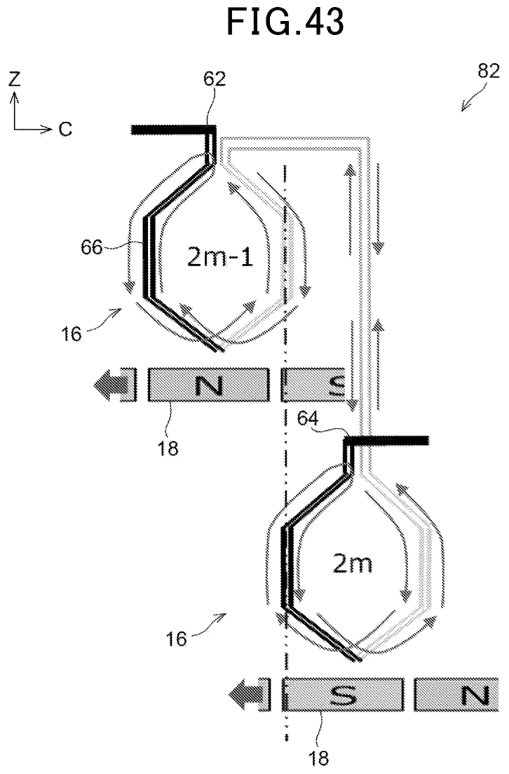

FIGS. 42 and 43 show a plurality of U-phase coils 16 of the motor 82 according to the present embodiment. As shown in these figures, the number of the U-phase coils 16 is set to an even number. That is, the number of the U-phase coils 16 is set to 2n (n is a natural number). More particularly, in the present embodiment, n is equal to 3. Hereinafter, the six U-phase coils 16 will be referred to as the first coil 16 to the sixth coil 16 in order from the second side to the first side in the circumferential direction. Moreover, counting the U-phase coils 16 from the opposite side to the neutral point 44, ends of the (2m-1)-th coil 16 on one side thereof are connected with each other via a first connection portion 62; ends of the 2m-th coil 16 on one side thereof are connected with each other via a second connection portion 64; and ends of the (2m-1)-th coil 16 on the other side thereof are connected respectively with ends of the 2m-th coil 16 on the other side thereof. In addition, m is a natural number that satisfies m<n. Consequently, a closed circuit 66 is formed to the two U-phase coils that are electrically continuous with each other.

Specifically, the U-phase coils 16 are configured identically to the coils 16 of the motor according to the sixth embodiment. A closed circuit 66 is formed which has two paths connected with each other by a first connection portion 62 and a second connection portion 64. One of the two paths includes the first straight portion A1 (outer) to the sixth straight portion C6 (inner) of the first coil 16 and the sixth straight portion C6 (outer) to the first straight portion A1 (inner) of the second coil 16. The other of the two paths includes the first straight portion A1 (inner) to the sixth straight portion C6 (outer) of the first coil 16 and the sixth straight portion C6 (inner) to the first straight portion A1 (outer) of the second coil 16.

Moreover, another closed circuit 66 is formed which has two paths connected with each other by a first connection portion 62 and a second connection portion 64. One of the two paths includes the first straight portion A1 (outer) to the sixth straight portion C6 (inner) of the third coil 16 and the sixth straight portion C6 (outer) to the first straight portion A1 (inner) of the fourth coil 16. The other of the two paths includes the first straight portion A1 (inner) to the sixth straight portion C6 (outer) of the third coil 16 and the sixth straight portion C6 (inner) to the first straight portion A1 (outer) of the fourth coil 16.

Furthermore, yet another closed circuit 66 is formed which has two paths connected with each other by a first connection portion 62 and a second connection portion 64. One of the two paths includes the first straight portion A1 (outer) to the sixth straight portion C6 (inner) of the fifth coil 16 and the sixth straight portion C6 (outer) to the first straight portion A1 (inner) of the sixth coil 16. The other of the two paths includes the first straight portion A1 (inner) to the sixth straight portion C6 (outer) of the fifth coil 16 and the sixth straight portion C6 (inner) to the first straight portion A1 (outer) of the sixth coil 16.

In addition, although not shown in the drawings, closed circuits 66 are also formed to the V-phase coils 16 and the W-phase coils 16 in the same manner as the closed circuits 66 formed to the above-described U-phase coils 16.

As shown in FIGS. 42 and 43, in the above-described motor 82 according to the present embodiment, one closed circuit 66 is formed to each corresponding pair of the coils 16 that are of the same phase and adjacent to each other in the circumferential direction. Consequently, it becomes possible to have the induced currents canceled out by each other in each corresponding pair of the coils 16. As a result, it becomes possible to suppress loss caused by the induced currents; thus, it becomes possible to achieve improvement in the torque of the motor 82 while suppressing increase in the size of the motor 82.

### Ninth Embodiment

Next, a motor according to the ninth embodiment will be described. It should be noted that: members and parts of the motor according to the ninth embodiment corresponding to those of the motor 10 according to the first embodiment are designated by the same reference signs as the corresponding members and parts of the motor 10 according to the first embodiment; and description of these parts and members will be omitted hereinafter.

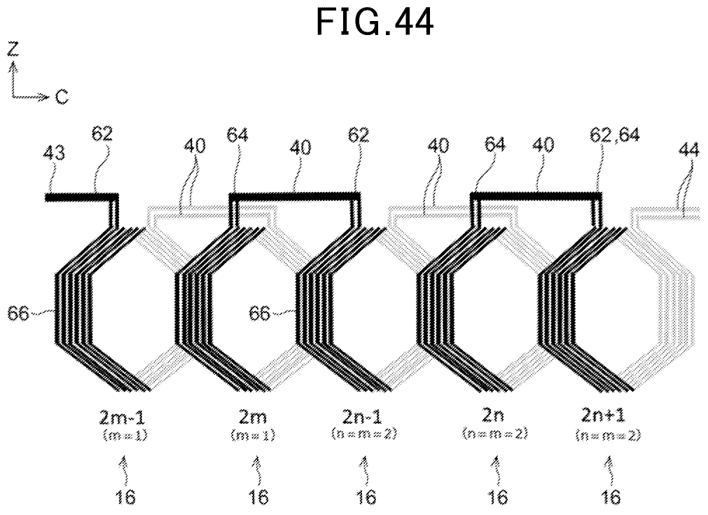

FIG. 44 shows a plurality of U-phase coils 16 of the motor according to the present embodiment. As shown in this figure, the number of the U-phase coils 16 is set to an odd number. That is, the number of the U-phase coils 16 is set to 2n+1 (n is a natural number). More particularly, in the present embodiment, n is equal to 2. Hereinafter, the five U-phase coils 16 will be referred to as the first coil 16 to the fifth coil 16 in order from the second side to the first side in the circumferential direction. Moreover, counting the U-phase coils 16 from the opposite side to the neutral point 44, ends of the (2m-1)-th coil 16 on one side thereof are connected with each other via a first connection portion 62; ends of the 2m-th coil 16 on one side thereof are connected with each other via a second connection portion 64; and ends of the (2m-1)-th coil 16 on the other side thereof are connected respectively with ends of the 2m-th coil 16 on the other side thereof. In addition, m is a natural number that satisfies m≤ n. Consequently, a closed circuit 66 is formed to the first coil 16 and the second coil 16 that are electrically continuous with each other; and another closed circuit 66 is formed to the third coil 16 and the fourth coil 16 that are electrically continuous with each other.

In addition, except for the following point, the arrangement and connection of the first coil 16 to the fifth coil 16 in the motor according to the present embodiment are the same as those in the motor 82 according to the eighth embodiment.

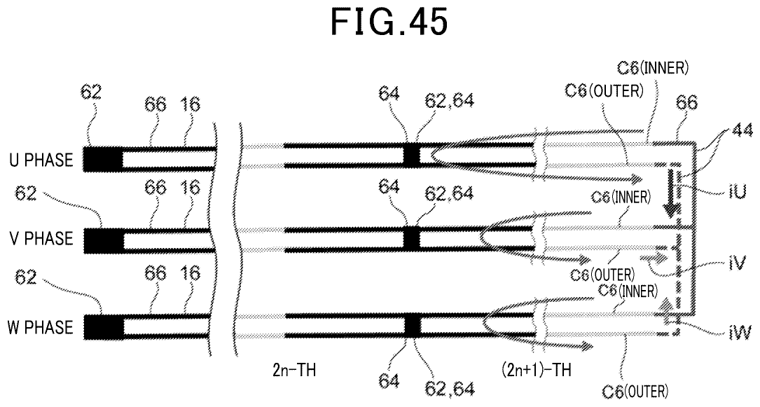

As shown in FIG. 45, in the motor according to the present embodiment, the sixth straight portion C6 (inner) of the fifth U-phase coil 16, the sixth straight portion C6 (inner) of the fifth V-phase coil 16 and the sixth straight portion C6 (inner) of the fifth W-phase coil 16 are connected with each other by the neutral point 44. Moreover, the sixth straight portion C6 (outer) of the fifth U-phase coil 16, the sixth straight portion C6 (outer) of the fifth V-phase coil 16 and the sixth straight portion C6 (outer) of the fifth W-phase coil 16 are connected with each other by the neutral point 44.

With the above configuration, a closed circuit 66 is formed which has two paths connected with each other by a U-phase first connection portion 62, a V-phase first connection portion 62 and a W-phase first connection portion 62. One of the two paths includes the first straight portion A1 (outer) to the sixth straight portion C6 (inner) of the fifth U-phase coil 16. The other of the two paths includes the first straight portion A1 (inner) to the sixth straight portion C6 (outer) of the fifth U-phase coil 16. That is, from the viewpoint of the U-phase, the V-phase first connection portion 62 and the W-phase first connection portion 62 function as a U-phase second connection portion 64.

Moreover, another closed circuit 66 is formed which has two paths connected with each other by the V-phase first connection portion 62, the U-phase first connection portion 62 and the W-phase first connection portion 62. One of the two paths includes the first straight portion A1 (outer) to the sixth straight portion C6 (inner) of the fifth V-phase coil 16. The other of the two paths includes the first straight portion A1 (inner) to the sixth straight portion C6 (outer) of the fifth V-phase coil 16. That is, from the viewpoint of the V-phase, the U-phase first connection portion 62 and the W-phase first connection portion 62 function as a V-phase second connection portion 64.

Furthermore, yet another closed circuit 66 is formed which has two paths connected with each other by the W-phase first connection portion 62, the U-phase first connection portion 62 and the V-phase first connection portion 62. One of the two paths includes the first straight portion A1 (outer) to the sixth straight portion C6 (inner) of the fifth W-phase coil 16. The other of the two paths includes the first straight portion A1 (inner) to the sixth straight portion C6 (outer) of the fifth W-phase coil 16. That is, from the viewpoint of the W-phase, the U-phase first connection portion 62 and the V-phase first connection portion 62 function as a W-phase second connection portion 64.

In the above-described motor according to the present embodiment, for the first coil 16 to the fourth coil 16 of each phase, the induced currents can be canceled out by each other in each corresponding pair of the coils 16 that are of the same phase and adjacent to each other in the circumferential direction. Moreover, in the motor according to the present embodiment, the induced current iU that is induced in the fifth coil 16 of one phase (i.e., the U phase in FIG. 45) can be canceled out by the induced currents iV and iW that are induced respectively in the fifth coils 16 of the remaining two phases (i.e., the V phase and the W phase in FIG. 45). Consequently, it becomes possible to suppress loss caused by the induced currents. As a result, it becomes possible to achieve improvement in the torque of the motor while suppressing increase in the size of the motor.

### Tenth Embodiment

Next, a motor 84 according to the tenth embodiment will be described. It should be noted that: members and parts of the motor 84 according to the tenth embodiment corresponding to those of the motor 10 according to the first embodiment are designated by the same reference signs as the corresponding members and parts of the motor 10 according to the first embodiment; and description of these parts and members will be omitted hereinafter.

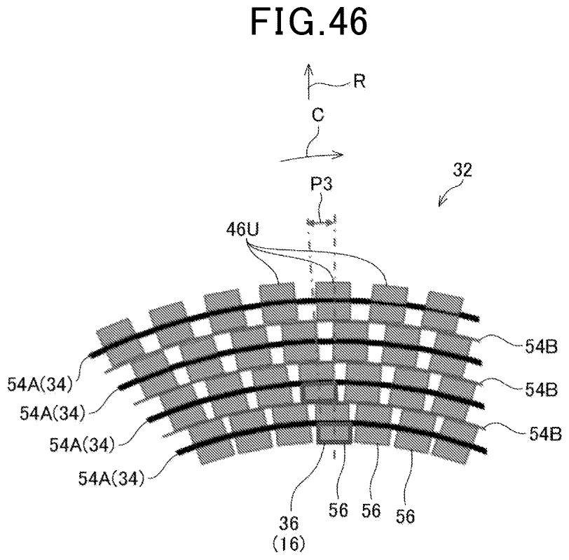

As shown in FIGS. 46 to 48, in the motor 84 according to the tenth embodiment, the coils 16 are radially stacked and arranged so that those coils 16 of a given phase which are formed in one layer are offset in the circumferential direction from those coils 16 of the given phase which are formed in another layer.

Specifically, those coils 16 which are arranged in the second layer are offset by an angle P3 to the second side in the circumferential direction from those coils 16 which are arranged in the first layer. Moreover, those coils 16 which are arranged in the third layer are offset by the angle P3 to the second side in the circumferential direction from those coils 16 which are arranged in the second layer. Furthermore, those coils 16 which are arranged in the fourth layer are offset by the angle P3 to the second side in the circumferential direction from those coils 16 which are arranged in the third layer. It should be noted that each of the coils 16 may be divided into two parts by a slit 60 formed therein as described above, or may not be divided (i.e., may have no slit 60 formed therein). In addition, in the drawings illustrating the present embodiment, there is shown an example where each of the coils 16 has no slit 60 formed therein.

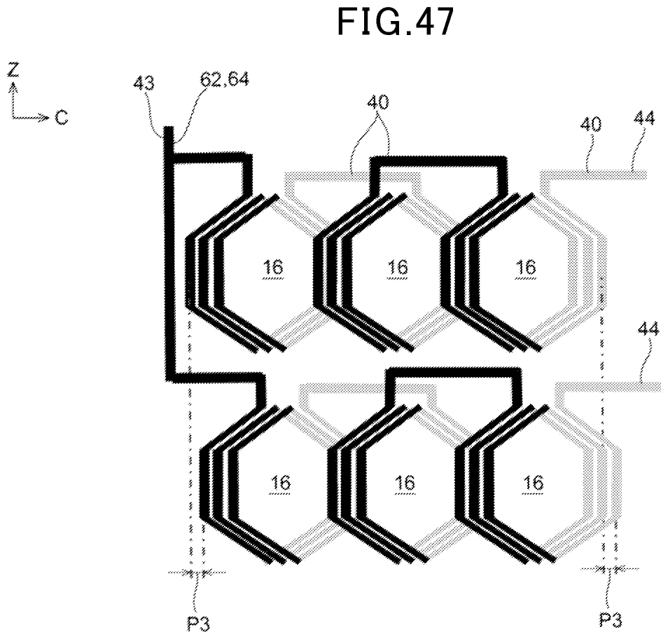

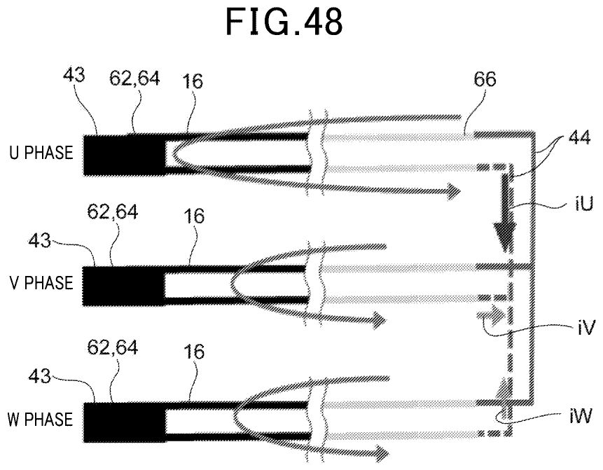

FIG. 47 is a schematic diagram showing three U-phase coils 16 arranged in the first layer and connected in series with each other and three U-phase coils 16 arranged in the second layer and connected in series with each other, with the three U-phase coils 16 arranged in the second layer being offset in the axial direction from the three U-phase coils 16 arranged in the first layer. As shown in this figure, a second end of the three serially-connected U-phase coils 16 arranged in the first layer and a second end of the three serially-connected U-phase coils 16 arranged in the second layer are connected in parallel with each other to form a first connection portion 62. In addition, although not shown in the drawings, the V-phase coils 16 and the W-phase coils 16 are configured in the same manner as the U-phase coils 16. Moreover, a first end of the three serially-connected U-phase coils 16 arranged in the first layer is connected with neutral-point-side ends of coils of the other phases. Here, the neutral-point-side ends of coils of the other phases denote a first end of three serially-connected V-phase coils 16 arranged in the first layer and a first end of three serially-connected W-phase coils 16 arranged in the first layer, as shown in FIG. 48. Similarly, a first end of the three serially-connected U-phase coils 16 arranged in the second layer is connected with neutral-point-side ends of coils of the other phases. Here, the neutral-point-side ends of coils of the other phases denote a first end of three serially-connected V-phase coils 16 arranged in the second layer and a first end of three serially-connected W-phase coils 16 arranged in the second layer, as shown in FIG. 48. With the above configuration, closed circuits 66 are formed which have the coils 16 of respective phases connected by the U-phase first connection portion 62, the V-phase first connection portion 62 and the W-phase first connection portion 62. That is, from the viewpoint of the U-phase, the V-phase first connection portion 62 and the W-phase first connection portion 62 function as a U-phase second connection portion 64. Moreover, from the viewpoint of the V-phase, the U-phase first connection portion 62 and the W-phase first connection portion 62 function as a V-phase second connection portion 64. Furthermore, from the viewpoint of the W-phase, the U-phase first connection portion 62 and the V-phase first connection portion 62 function as a W-phase second connection portion 64.

In the above-described motor 84 according to the tenth embodiment, the induced current iU that is induced in the U-phase coils 16 in the first and second layers can be canceled out by the induced current iV that is induced in the V-phase coils 16 in the first and second layers and the induced current iW that is induced in the W-phase coils 16 in the first and second layers. Moreover, since the first to the fourth layers are configured in the same manner, the induced currents that are induced in the coils 16 of each phase can also be canceled out between the second and third layers, between the third and fourth layers and between the fourth and first layers. Consequently, it becomes possible to suppress loss caused by the induced currents. As a result, it becomes possible to achieve improvement in the torque of the motor 84 while suppressing increase in the size of the motor 84.

Furthermore, in the present embodiment, the coils 16 are radially stacked and arranged so that those coils 16 of a given phase which are formed in one layer are offset in the circumferential direction from those coils 16 of the given phase which are formed in another layer. Consequently, it becomes possible to realize sequential and stepwise switching of magnetic flux. As a result, it becomes possible to make the motor 84 quiet while making rotation of the motor 84 (i.e., rotation of the rotor 12) smooth. It should be noted that the offset angle P3 of the coils 16 may be set to be constant or to vary between layers. It also should be noted that the offset angle P3 of the coils 16 may include an unintended offset angle due to manufacturing tolerances of the coil assembly 32. In addition, in the case of each of the coils 16 being divided into two parts by a slit 60 formed therein as described above, it is possible to configure the motor by combining the present embodiment with any of the first to the ninth embodiments.

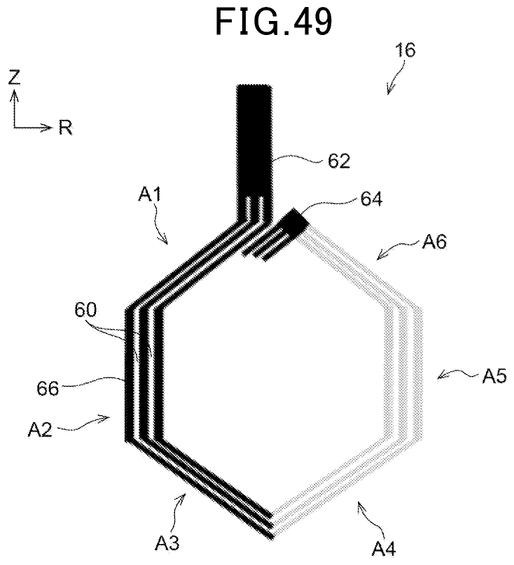

In the above-described embodiments, each of the straight portions of the coils 16 is divided into two parts by a slit 60 formed therein. Alternatively, as in a motor according the eleventh embodiment shown in FIG. 49, each of the straight portions of the coils 16 may be divided, for example, into three parts by two slits 60 formed therein. Moreover, although not shown in the drawings, each of the straight portions of the coils 16 may be divided into four or more parts by three or more slits 60 formed therein.

While the above embodiments of the present disclosure have been described, it will be understood by those skilled in the art that the present disclosure is not limited to the above embodiments, but may be carried out through various modifications without departing from the spirit of the present disclosure. Moreover, all or some of the configurations of the motors according the above embodiments may be combined with each other.

For example, although the embodiments in which the coils 16 formed on the band member 34 are star-connected have been illustrated, they may alternatively be delta-connected. Moreover, the number of poles, the number of coils, the number of phases, the number of coils connected in series with each other, the number of coils connected in parallel with each other, and the like of the motor 10 may be set properly according to the application of the motor 10. Furthermore, the configuration of the motor 10 can also be applied to an electric generator. Moreover, the configuration of the motor 10 can also be applied to an outer rotor type brushless motor in which a rotor 12 is arranged radially outside a stator 14. Furthermore, the configuration of the coil assembly 32 according to the present disclosure can also be applied to a rotor that includes a coil assembly 32.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. A coil assembly comprising:
a band member formed of an electrically-insulative material into a band shape and rolled along a circumferential direction;
a plurality of coils formed of an electroconductive material on the band member and arranged in alignment with each other along the circumferential direction, the plurality of coils having a plurality of paths through which electric current flows and which constitute parts of a closed circuit;
a first connection portion constituting a part of the closed circuit and connecting between the plurality of paths; and
a second connection portion constituting another part of the closed circuit and connecting between the plurality of paths or between the plurality of coils so that induced currents, which are induced in the closed circuit by electromagnetic induction due to movement of magnets in the circumferential direction, are canceled out by each other in the closed circuit,
wherein:
the plurality of paths include a first path and a second path that are arranged side by side in the circumferential direction;
each of coil portions of at least some of the plurality of coils is divided into a first part and a second part in a direction intersecting an extending direction of the coil portion;
the first parts of the coil portions constitute the first path, and the second parts of the coil portions constitute the second path; and
the first path and the second path are connected with each other by the first connection portion and the second connection portion to form the closed circuit.

2. The coil assembly as set forth in claim 1, wherein:
each of the plurality of coils has a plurality of turns; and
to each of the plurality of turns, there is formed one closed circuit.

3. The coil assembly as set forth in claim 1, wherein:
each of the plurality of coils has a plurality of turns; and
to each of the plurality of coils, there is formed one closed circuit.

4. The coil assembly as set forth in claim 1, wherein
to the plurality of coils, there is formed one closed circuit.

5. The coil assembly as set forth in claim 1, wherein:
axial positions of those parts in the paths of the coils where the coils are folded back from a first side to a second side in an axial direction are set to be the same as each other; and
axial positions of those parts in the paths of the coils where the coils are folded back from the second side to the first side in the axial direction are set to be the same as each other.

6. The coil assembly as set forth in claim 5, wherein:
the number of the coils of a same phase is 2n, where n is a natural number;
counting the coils of the same phase in order from one side to the other side in the circumferential direction, the first and second parts of the coil portion at one end of the (2m-1)-th coil are connected with each other via the first connection portion, the first and second parts of the coil portion at one end of the 2m-th coil are connected with each other via the second connection portion, and the first and second parts of the coil portion at the other end of the (2m-1)-th coil are connected respectively with the first and second parts of the coil portion at the other end of the 2m-th coil, where m is a natural number that satisfies m≤ n; and
one closed circuit is formed to every two coils of the same phase that are electrically continuous with each other.

7. The coil assembly as set forth in claim 5, wherein:
the number of the coils of a same phase is 2n+1, where n is a natural number;
counting the coils of the same phase in order from one side to the other side in the circumferential direction, the first and second parts of the coil portion at one end of the (2m-1)-th coil are connected with each other via the first connection portion, the first and second parts of the coil portion at one end of the 2m-th coil are connected with each other via the second connection portion, and the first and second parts of the coil portion at the other end of the (2m-1)-th coil are connected respectively with the first and second parts of the coil portion at the other end of the 2m-th coil, where m is a natural number that satisfies m≤n;
for the (2m-1)-th coil to the 2n-th coil, one closed circuit is formed to every two coils of the same phase that are electrically continuous with each other; and
one closed circuit is formed to the (2n+1)-th coil of one phase and the (2n+1)-th coil of another phase.

8. The coil assembly as set forth in claim 1, wherein:
the band member has a plurality of layers in a radial direction; and
the plurality of coils are radially stacked and arranged so that those coils of a given phase which are formed in one layer are offset in the circumferential direction from those coils of the given phase which are formed in another layer.

9. An armature comprising the coil assembly as set forth in claim 1.

10. A rotating electric machine comprising:
a stator, and
a rotor,
wherein:
one the stator and the rotor includes the armature as set forth in claim 9, and the other of the stator and the rotor has the magnets arranged to radially face the coil assembly.
